(19) United States
(12) Patent Application Publication
(10) Pub. No.: US 2014/0204064 A1
(43) Pub. Date: Jul. 24, 2014

(54) TIMING CONTROL CIRCUIT, IMAGE DRIVING APPARATUS, IMAGE DISPLAY SYSTEM AND DISPLAY DRIVING METHOD

(71) Applicant: NOVATEK MICROELECTRONICS CORP., Hsinchu (TW)

(72) Inventor: Min-Jung Chen, Taipei City (TW)

(73) Assignee: NOVATEK MICROELECTRONICS CORP., Hsinchu (TW)

(21) Appl. No.: 13/781,783

(22) Filed: Mar. 1, 2013

(30) Foreign Application Priority Data
Jan. 18, 2013 (TW) 102102044

(51) Int. Cl. G09G 5/00

(52) U.S. Cl. CPC G09G 5/001
USPC 345/204

(57) ABSTRACT

A timing control circuit configured to drive a source driver circuit is provided. The timing control circuit includes a signal receiving unit and a signal output unit. The signal receiving unit receives an input signal. The input signal includes an image signal. The signal output unit generates an output signal according to the input signal. The output signal includes the image signal. A period when the input signal corresponds to a static image includes one or more frame partially-masked periods. During a first time interval of the frame partially-masked period, the image signal of the output signal is not masked but output by the signal output unit. During a second time interval of the frame partially-masked period, the image signal of the output signal is masked but not output by the signal output unit. Furthermore, a display driving method of a display panel is also provided.

### CROSS-REFERENCE TO RELATED APPLICATION

This application claims the priority benefit of Taiwan application serial no. 102102044, filed on Jan. 18, 2013. The entirety of the above-mentioned patent application is hereby incorporated by reference herein and made a part of this specification.

### BACKGROUND

1. Field of the Disclosure

The disclosure is directed to a timing control circuit, an image driving apparatus and an image display system. More particularly, the disclosure is directed to a timing control circuit, an image driving apparatus and an image display system capable of providing a power down function or a power saving function.

2. Description of Related Art

With reference to FIG. 1, FIG. 1 is a schematic diagram illustrating a plurality of pixels on a display panel. On a display panel 100, each cell 110 may be equivalent to a pixel capacitor. When frame data of an image signal is written into the pixel capacitor, the pixel capacitor is charged and maintained at a voltage level set by the frame data. As time progresses, the pixel capacitor gradually deviates from the set voltage level due to leakage. Thus, no mater whether a dynamic image or a static image is displayed on the display panel, an image driving apparatus has to update the frame data of the pixel capacitor at a specific frame rate.

Generally, the image driving apparatus updates the frame data of the pixel capacitor at a frame rate of 60 Hz, i.e. the image content is updated 60 times per second, and the pixel capacitor would be charged to the predetermined voltage level per update. Thus, in the architecture of the image display system of the related art, a chipset inputs the frame data to a timing control circuit at a frequency of 60 Hz, and in the meantime, the timing control circuit also updates the display panel at the frequency of 60 Hz. However, in the related art, no matter whether the dynamic image or the static image is to be displayed on the display panel, the chipset continuously outputs the frame data to the timing control circuit, which leads the image display system to overly high power consumption when displaying the static image or not requiring a fast response time.

### SUMMARY

The disclosure is directed to a timing control circuit capable of providing a power down function according to whether a dynamic image or a static image is displayed.

The disclosure is directed to an image driving apparatus capable of providing a power down function according to whether a dynamic image or a static image is displayed.

The disclosure is directed to an image display system capable of providing a power down function according to whether a dynamic image or a static image is displayed.

The disclosure is directed to a timing control circuit configured to drive a source driver circuit. The timing control circuit includes a signal receiving unit and a signal output unit. The signal receiving unit is configured to receive an input signal. The input signal includes an image signal. The signal output unit is configured to generate an output signal according to the input signal. The output signal includes an image signal. A period when the image signal corresponds to a static image includes one or more frame partially-masked periods. Each of the frame partially-masked periods includes a first time interval and a second time interval. During the first time interval, the image signal of the output signal is not masked but output by the signal output unit, and during the second time interval, the image signal of the output signal is masked but not output by the signal output unit.

In an embodiment of the disclosure, during the first time interval of each of the frame partially-masked periods, the signal output unit outputs N frame data of the image signal. During the second time interval of each of the frame partially-masked periods, the signal output unit does not output M frame data of the image signal. M and N are positive integers.

In an embodiment of the disclosure, during the second time interval of each of the frame partially-masked periods, the signal output unit further enters a power down mode or a power saving mode.

In an embodiment of the disclosure, during the second time interval of each of the frame partially-masked periods, the signal output unit further controls the source driver circuit to enter a power down mode or a power saving mode.

In an embodiment of the disclosure, during the entire time of each of the frame partially-masked periods, generation of the image signal of the input signal is stopped, and the image signal of the input signal is not received by the signal receiving unit.

In an embodiment of the disclosure, during the first time interval of each of the frame partially-masked periods, the image signal of the input signal is not masked but received by the signal receiving unit. During the second time interval of each of the frame partially-masked periods, the image signal of the input signal is masked but not received by the signal receiving unit.

In an embodiment of the disclosure, the entire time of each of the frame partially-masked periods, the image signal of the input signal received by the signal receiving unit is not masked.

In an embodiment of the disclosure, during the second time interval of each of the frame partially-masked periods, the signal output unit masks the image signal.

In an embodiment of the disclosure, the timing control circuit further includes an image determination unit. The image determination unit is configured to determine whether an image corresponding to the input signal is a static image. If yes, the image determination unit instructs the signal output unit not to mask the image signal during the first time interval of each of the frame partially-masked periods, and the image determination unit instructs the signal output unit to mask the image signal during the second time interval of each of the frame partially-masked periods.

In an embodiment of the disclosure, the image determination unit determines whether the image signal corresponds to the static image according to cyclic redundancy check (CRC) of a plurality of frame data of the image signal.

In an embodiment of the disclosure, the timing control circuit further includes a frame buffer unit. The frame buffer unit is coupled between the signal receiving unit and the signal output unit. The frame buffer unit is configured to receive and store at least one frame data of the image signal of the input signal so as to provide the at least one frame data to the signal output unit.

In an embodiment of the disclosure, the signal output unit is directly connected to the signal receiving unit so as to directly receive at least one frame data of the image signal of the input signal and generate the output signal according to the at least one frame data.

In an embodiment of the disclosure, the timing control circuit operates in at least one of four modes which are a panel self refresh (PSR) mode, a normal determination mode, a frame buffer determination mode and a system determination mode.

In the PSR mode, the timing control circuit includes a frame buffer unit coupled between the signal receiving unit and the signal output unit. The timing control circuit receives an external notification about whether an image corresponding to the input signal is a static image. When the timing control circuit is notified that the image corresponding to the input signal is the static image, the signal receiving unit temporarily stores at least one frame data of the image signal of the input signal in the frame buffer unit. The signal output unit generates the output signal according to the at least one temporarily stored frame data during the first time interval of each of the frame partially-masked periods, and the signal output unit masks the image signal during the second time interval of each of the frame partially-masked periods.

In the normal determination mode, the signal output unit is directly connected to the signal receiving unit. The timing control circuit self-determines whether the image corresponding to the input signal is the static image. According to a determination result, the timing control circuit generates and outputs the output signal by directly using the at least one frame data of the image signal of the input signal received from the signal receiving unit during the first time interval of each of the frame partially-masked periods, and the timing control circuit masks the image signal during the second time interval of each of the frame partially-masked periods.

In the frame buffer determination mode, the timing control circuit includes a frame buffer unit coupled between the signal receiving unit and the signal output unit. The timing control circuit self-determines whether the image corresponding to the input signal is a static image. When the static image is detected by the timing control circuit, the signal receiving unit temporarily stores the at least one frame data of the image signal of the input signal in the frame buffer unit. The signal output unit generates the output signal according to the at least one temporarily stored frame data during the first time interval of each of the frame partially-masked periods, and the signal output unit masks the image signal during the second time interval of each of the frame partially-masked periods.

In the system determination mode, the signal output unit is directly connected to the signal receiving unit. During the first time interval of each of the frame partially-masked periods, the image signal of the input signal is not masked, and the signal output unit outputs the image signal of the output signal directly according to the image signal of the input signal, and during the second time interval of each of the frame partially-masked periods, the image signal of the input signal is masked, and the signal output unit does not output the image signal of the output signal in response to the masked input signal.

In an embodiment of the disclosure, during each of the frame partially-masked periods, a frame rate of the image signal is adjusted to be lower than that of the image signal corresponding to a dynamic image.

The disclosure is directed to an image driving apparatus configured to drive a display panel. The image driving apparatus includes a timing control circuit and at least one source driver circuit. The timing control circuit is configured to receive an input signal and generates an output signal according to the input signal. The input signal and the output signal include an image signal. Each of the at least one source driver circuit is coupled to the timing control circuit and configured to receive the output signal and drive the display panel according to the output signal. A period when the image signal corresponds to a static image includes one or more frame partially-masked periods. Each of the frame partially-masked periods includes a first time interval and a second time interval. During the first time interval, the image signal of the output signal is not masked but output by the timing control circuit, and during the second time interval, the image signal of the output signal is masked but not output by the timing control circuit.

In an embodiment of the disclosure, during the first time interval of each of the frame partially-masked periods, the timing control circuit outputs N frame data of the image signal, and during the second time interval of each of the frame partially-masked periods, the timing control circuit does not output M frame data of the image signal of the output signal. M and N are positive integers.

In an embodiment of the disclosure, during the second time interval of each of the frame partially-masked periods, the timing control circuit further enters a power down mode or a power saving mode.

In an embodiment of the disclosure, during the second time interval of each of the frame partially-masked periods, the timing control circuit further controls the source driver circuit to enter a power down mode or a power saving mode.

In an embodiment of the disclosure, during the entire time of each of the frame partially-masked periods, generation of the image signal of the input signal is stopped, and the image signal of the input signal is not received by the timing control circuit.

In an embodiment of the disclosure, during the first time interval of each of the frame partially-masked periods, the image signal of the input signal is not masked but received by the timing control circuit, and during the second time interval of each of the frame partially-masked periods, the image signal of the input signal is masked but not received by the timing control circuit.

In an embodiment of the disclosure, during the entire time of each of the frame partially-masked periods, the image signal of the input signal received by the timing control circuit is not masked.

In an embodiment of the disclosure, during the second time interval of each of the frame partially-masked periods, the timing controller circuit masks the image signal.

In an embodiment of the disclosure, the timing control circuit determines whether the image signal corresponds to the static image according to cyclic redundancy check (CRC) of a plurality of frame data of the image signal so as to determine whether to mask the image signal according to a determination result.

In an embodiment of the disclosure, after receiving the input signal, the timing control circuit temporarily stores one or more frame data of the image signal and generates the output signal according to the one or more temporarily stored frame data.

In an embodiment of the disclosure, after receiving the input signal, the timing control circuit does not temporarily store one or more frame data of the image signal but instead generates the output signal directly according to the one or more frame data of the image signal.

In an embodiment of the disclosure, the timing control circuit operates in at least one of four modes which are a PSR mode, a normal determination mode, a frame buffer determination mode and a system determination mode.

In the PSR mode, the timing control circuit receives an external notification about whether an image corresponding to the input signal is the static image. The Riming control circuit temporarily stores at least one frame data of the image signal of the input signal when being notified that the image corresponding to the input signal is the static image. The timing control circuit generates the output signal according to the at least one temporarily stored frame data during the first time interval of each of the frame partially-masked periods. The timing control circuit masks the image signal during the second time interval of each of the frame partially-masked periods.

In the normal determination mode, the timing control circuit self-determines whether the image corresponding to the input signal is the static image. According to a determination result, the timing control circuit generates and outputs the output signal by directly using the at least one frame data of the image signal of the received input signal during the first time interval of each of the frame partially-masked periods, and the timing control circuit masks the image signal during the second time interval of each of the frame partially-masked periods.

In the frame buffer determination mode, the timing control circuit self-determines whether the image corresponding to the input signal is the static image. The timing control circuit temporarily stores the at last one frame data of the image signal of the input signal when detecting the static image. The timing control circuit generates the output signal according to the at least one temporarily stored frame data during the first time interval of each of the frame partially-masked periods, and the timing control circuit masks the image signal during the second time interval of each of the frame partially-masked periods.

In the system determination mode, during the first time interval of each of the frame partially-masked periods, the image signal of the input signal is not masked, and the timing control circuit outputs the image signal of the output signal directly according to the image signal of the input signal. During the second time interval of each of the frame partially-masked periods, the image signal of the input signal is masked, and the timing control circuit does not output the image signal of the output signal in response to the masked input signal.

In an embodiment of the disclosure, during each of the frame partially-masked periods, a frame rate of the image signal is adjusted to be lower than that of the image signal corresponding to a dynamic image.

The disclosure is directed to an image display system including a front-end system circuit, a display driving apparatus and a display panel. The front-end system circuit is configured to provide an input signal. The input signal includes an image signal. The display driving apparatus includes a timing control circuit and at least one source driver circuit. The timing control circuit is coupled to the front-end system circuit and configured to receive the input signal and generate an output signal according to the input signal. The output signal includes the image signal. A period when the image signal corresponds to a static image includes one or more frame partially-masked periods. During the first time interval, the image signal of the output signal is not masked but output by the signal output unit, and during the second time interval, the image signal of the output signal is masked but not output by the signal output unit. The source driver circuit is coupled to the timing control circuit and configured to receive the output signal and drive the display panel according to the output signal. The display panel is configured to be driven by the source driver circuit to display an image frame.

In an embodiment of the disclosure, during the first time interval of each of the frame partially-masked periods, the timing control circuit outputs N frame data of the image signal, and during the second time interval of each of the frame partially-masked periods, M frame data of the image signal is masked but not output by the timing control circuit. M and N are positive integers.

In an embodiment of the disclosure, during the second time interval of each of the frame partially-masked periods, the timing control circuit further enters a power down mode or a power saving mode.

In an embodiment of the disclosure, during the second time interval of each of the frame partially-masked periods, the timing control circuit further controls the source driver circuit to enter a power down mode or a power saving mode.

In an embodiment of the disclosure, the front-end system circuit determines whether the image signal corresponds to the static image. According to a determination result, the front-end system circuit instructs the timing control circuit not to mask the image signal but to output the image signal of the output signal during the first time interval of each of the frame partially-masked periods, and the front-end system circuit instructs the timing control circuit to mask the image signal but not to output the image signal of the output signal during the second time interval of each of the frame partially-masked periods.

In an embodiment of the disclosure, during the entire time of each of the frame partially-masked periods, the front-end system circuit further stops generating the image signal of the input signal.

In an embodiment of the disclosure, when the front-end system circuit does not generate the image signal of the input signal, the front-end system circuit operates in a power down mode or a power saving mode.

In an embodiment of the disclosure, the front-end system circuit determines whether the image signal corresponds to the static image, such that according to a determination result, the front-end system circuit does not mask the image signal but outputs the image signal of the input signal is during the first time interval of each of the frame partially-masked periods, and the front-end system circuit masks the image signal but does not output the image signal of the input signal during the second time interval of each of the frame partially-masked periods.

In an embodiment of the disclosure, when the front-end system circuit does not generate the image signal of the input signal, the front-end system circuit operates in a power down mode or a power saving mode. When front-end system circuit generates the image signal of the input signal, the front-end system circuit operates in a power on mode.

In an embodiment of the disclosure, no matter whether the front-end system circuit generates the image signal of the input signal, the front-end system circuit operates in a power on mode.

In an embodiment of the disclosure, the image signal of the input signal received by the timing control circuit is not masked. The timing control circuit determines whether the image signal corresponds to the static image, and according to a determination result, the timing control circuit does not mask but outputs the image signal of the output signal during the first time interval of each of the frame partially-masked periods, and the timing control circuit masks but does not output the image signal of the output signal during the second time interval of each of the frame partially-masked periods.

In an embodiment of the disclosure, after receiving the input signal, the timing control circuit temporarily stores one or more frame data of the image signal and then generates the output signal according to the one or more temporarily stored frame data.

In an embodiment of the disclosure, after receiving the input signal, the timing control circuit does not temporarily store the one or more frame data of the image signal but instead generates the output signal directly according to the one or more frame data of the image signal.

In an embodiment of the disclosure, the timing control circuit operated in at least one of four modes which are a PSR mode, a normal determination mode, a frame buffer determination mode and a system determination mode.

In the PSR mode, the front-end system circuit determines whether the image signal corresponds to the static image, such that when the image signal corresponds to the static image, the front-end system circuit instructs the timing control circuit to temporarily store one or more frame data of the image signal after the timing control circuit receives the input signal, and the front-end system circuit instructs the timing control circuit to generate the output signal according to the one or more temporarily stored frame data during the first time interval of each of the frame partially-masked periods, and the front-end system circuit instructs the timing control circuit to mask but not to output the image signal of the output signal during the second time interval of each of the frame partially-masked periods.

In the normal determination mode, the timing control circuit self-determines whether the image corresponding to the input signal is the static image, such that after receiving the input signal, the timing control circuit generates the output signal according to a determination result and directly according to the one or more frame data of the image signal during the first time interval of each of the frame partially-masked periods, and the timing control circuit masks the image signal during the second time interval of each of the frame partially-masked periods.

In the frame buffer determination mode, the timing control circuit self-determines whether the image corresponding to the input signal is a static image. When the image signal corresponds to the static image, the timing control circuit temporarily stores one or more frame data of the image signal first after the timing control circuit receives the input signal. The timing control circuit generates the output signal according to the one or more temporarily stored one or more frame data during the first time interval of each of the frame partially-masked periods, and the timing control circuit masks the image signal during the second time interval of each of the frame partially-masked periods.

In the system determination mode, the front-end system circuit determines whether the image signal corresponds to a static image, such that according to a determination result, the front-end system circuit does not mask but outputs the image signal of the input signal. The timing control circuit outputs the image signal of the output signal directly according to the image signal of the input signal during the first time interval of each of the frame partially-masked periods, and the front-end system circuit masks but does not output the image signal of the input signal, and the timing control circuit does not output the image signal of the output signal in response to the masked input signal during the second time interval of each of the frame partially-masked periods.

In an embodiment of the disclosure, during each of the frame partially-masked periods, a frame rate of the image signal is adjusted to be lower than that of the image signal corresponding to a dynamic image.

The disclosure is directed to a display driving method including the following steps: (i) receiving an input signal including an image signal, (ii) generating an output signal according to the input signal, wherein the output signal includes the image signal and is configured to drive a source driver circuit, (iii) determining whether the image signal corresponds to a static image and (iv) arranging one or more frame partially-masked periods during a period when the image signal corresponds to a static image. Each of the frame partially-masked periods includes a first time interval and a second time interval. During the first time interval, the image signal of the output signal is not masked but output, and during the second time interval, the image signal of the output signal is masked but not output.

In an embodiment of the disclosure, during the first time interval of each of the frame partially-masked periods, N frame data of the image signal is not masked, and during the second time interval of each of the frame partially-masked periods, M frame data of the image signal is masked. M and N are positive integers.

In an embodiment of the disclosure, the display driving method further includes masking the image signal of the input signal during the second time interval of each of the frame partially-masked periods.

In an embodiment of the disclosure, the display driving method further includes stopping generating the image signal of the input signal during the entire time of each of the frame partially-masked periods.

In an embodiment of the disclosure, step (iii) is performed before step (i).

In an embodiment of the disclosure, step (iii) is performed after step (i).

In an embodiment of the disclosure, the display driving method further includes adjusting an frame rate of the of the image signal to be lower than that of the image signal corresponding to a dynamic image during each of the frame partially-masked periods.

In order to make the aforementioned and other features and advantages of the disclosure more comprehensible, several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a plurality of pixels on a display panel.

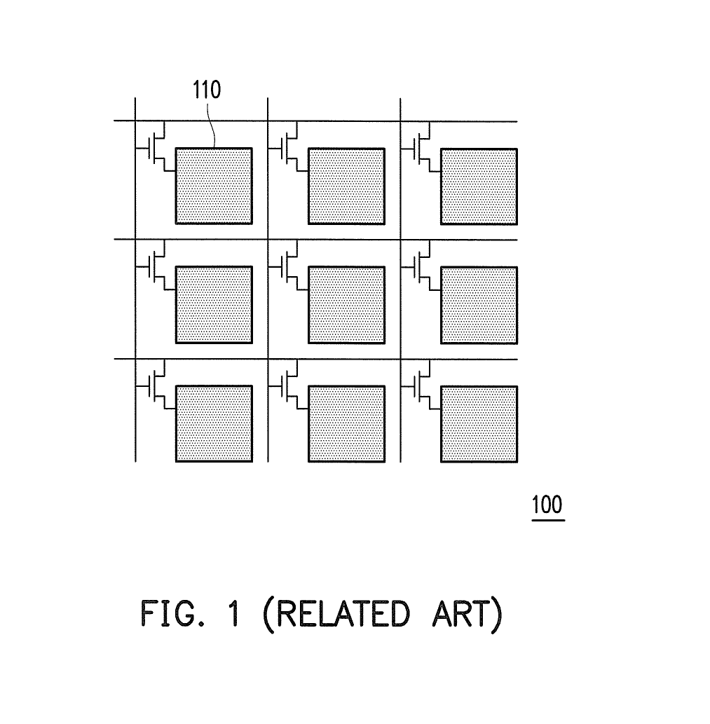

FIG. 2 is a schematic diagram illustrating an image display system according to an exemplary embodiment of the disclosure.

FIG. 3 is a schematic diagram illustrating the internal configuration of the timing control circuit according to an exemplary embodiment of the disclosure.

FIG. 4 illustrates schematic waveforms of the input signal and the output signal depicted in FIG. 3.

FIG. 5 is a flowchart illustrating a display driving method according to an exemplary embodiment of the disclosure.

FIG. 6 is a schematic diagram illustrating the internal configuration of the timing control circuit according to another exemplary embodiment of the disclosure.

FIG. 7A and FIG. 7B respectively illustrate schematic waveforms of the input signal and the output signal depicted in FIG. 6 when entering a static driving period and exiting from the static driving period.

FIG. 8 is a flowchart illustrating a display driving method according to another exemplary embodiment of the disclosure.

FIG. 9 is a schematic diagram illustrating the internal configuration of the timing control circuit according to still another exemplary embodiment of the disclosure.

FIG. 10A and FIG. 10B respectively illustrate schematic waveforms of the input signal and the output signal depicted in FIG. 9 when entering a static driving period and exiting from the static driving period.

FIG. 11 is a flowchart illustrating a display driving method according to still another exemplary embodiment of the disclosure.

FIG. 12 is a schematic diagram illustrating the internal configuration of a timing control circuit according to yet another exemplary embodiment of the disclosure.

FIG. 13 illustrates schematic waveforms of the input signal and the output signal depicted in FIG. 12.

FIG. 14 is a flowchart illustrating a display driving method according to yet another exemplary embodiment of the disclosure.

### DESCRIPTION OF EMBODIMENTS

The disclosure is described below by means of a plurality of embodiments. However, the disclosure is not limited to the illustrated embodiments. Further, the following embodiments may be adaptively combined, replaced or omitted under reasonable circumstances to meet different practical needs. Throughout the full context of the description and the claims, the word “couple” in the description and claims may refer to any direct or indirect connection. For instance, in the description and claims, if a first device is coupled to a second device, it means that the first device may be directly connected to the second device or may indirectly connected to the second device through another device or by another connection means. In addition, the word “signal” may refer to at least one current signal, voltage signal, electric charge signal, temperature signal, data signal or any one or more signals.

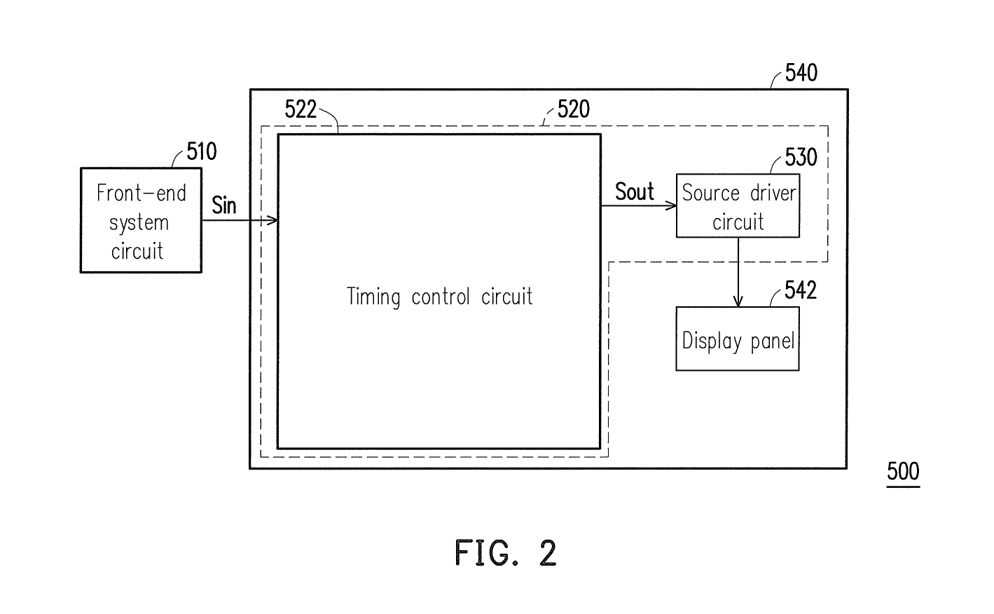

Referring to FIG. 2, FIG. 2 is a schematic diagram illustrating an image display system according to an exemplary embodiment of the disclosure. In the present exemplary embodiment, an image display system 500 includes a front-end system circuit 510 an image display apparatus 540. The image display apparatus 540 includes a display driving apparatus 520 and a display panel 542. The display driving apparatus 520 includes a timing control circuit 522 and a source driver circuit 530.

In the present exemplary embodiment, the display driving apparatus 520 includes the timing control circuit 522 capable of being coupled to the front-end system circuit 510 and configured to receive an input signal Sin and generate an output signal Sout according to the input signal Sin.

The input signal Sin includes an image signal. The image signal includes frame data. In other exemplary embodiment, the input signal Sin may further includes a control signal. Moreover, in some embodiments, the control signal may control the timing control circuit 522 to enter a power down mode or a power saving mode the image signal corresponds to a static image. When entering the power down mode, a circuit block of a system or an apparatus enters a state of stopping receiving, processing or transmitting signals to avoid power consumption. Alternatively, when entering a power saving mode, the circuit block of the system or the apparatus merely executes a necessary function for the system or the apparatus to return to the normal operation so as to reduce power consumption. Thus, when entering the power down mode or the power saving mode, it means that the circuit block of the system or the apparatus enters an operation mode of lower power consumption. In some embodiments, the control signal may be embedded in the image signal of the input signal Sin. Hence, the input signal Sin is not limited to including another control signal that is separated from the image signal.

The source driver circuit 530 is coupled to the timing control circuit 522 and configured to receive the output signal Sout and drive the display panel 540 according to the output signal Sout. The display panel 540 is configured to be driven by the source driver circuit 530 to display images. FIG. 2 illustrates only a source driver circuit 530 configured to drive the display panel 540; however, the number of the source driver circuit 530 does not construct any limitation to the disclosure. In different embodiments, the image display system may include one or more source driver circuits.

The output signal Sout also includes the image signal. Even though to be in brief, the output signal Sout is described herein as the image signal included in the input signal Sin, the input signal Sin actually includes frame information or frame data corresponding to the image signal whose format may be transformed to delete or add a part of the information. In other words, the input signal Sin includes frame information or frame data and output signal Sout is then generated according to entire or at least a part of the frame information or the frame data. As similar to the input signal Sin, in other embodiments, the output signal Sout may further include a control signal. Moreover, in some embodiments, the control signal may control the source driver circuit 530 to enter the power down mode or the power saving mode the image signal corresponds to a static image. In some embodiments, the control signal may also be embedded in the image signal of the output signal Sout. Accordingly, the input signal Sin is not limited to including another control signal that is separated from the image signal.

In the present exemplary embodiment, a period when the image signal corresponds to a static image includes one or more frame partially-masked periods. Each of the frame partially-masked periods includes a first time interval and a second time interval. During the first time interval, the image signal of the output signal is not masked but output by the timing control circuit 522. During the second time interval, the image signal of the output signal Sout is masked but not output by the timing control circuit 522.

It should be noticed that in some embodiments of the disclosure, the description that “the image signal is masked but not output” means that at least the frame data in the image signal is masked but not output, while in other embodiments, other more data in the image signal may be masked. Moreover, it should be further noticed that in the present exemplary embodiment, it is only an implementation scenario where the image signal is not output when the image signal is masked. For instance, in other embodiments, when the image signal is masked, a signal of a specific voltage or format may still be output without outputting the frame data, but the disclosure is not limited thereto.

In an exemplary embodiment, a period of generating a static image includes one or more frame partially-masked periods. The frame partially-masked periods may be consecutively arranged, and each of the frame partially-masked periods includes a first interval (also referred to as an active interval) and a second interval (also referred to as a power-saving interval). During the first interval, the signal output unit outputs N frame data of the image signal, and during the second interval, the signal output unit does not output M frame data of the image signal. Therein, M and N are positive integers. In other words, during the frame partially-masked periods, N frame data is output and M frame data is not (during a frame partially-masked period) and then, N frame data is output and M frame data is not (during the next frame partially-masked period) and so on. In brief, outputting and not outputting the frame data is periodically alternated with each other. A ratio of M to N may be adjusted, for example, according to features of a panel.

In addition, in an exemplary embodiment, but not limited to, when the image signal of the output signal Sout is masked, the timing control circuit 522 may further control the source driver circuit 530 to enter the power down mode or the power saving mode (i.e. any operation mode with lower power consumption). In some embodiments, when the image signal of the output signal Sout is masked, the timing control circuit 522 may further generate a control signal to control the source driver circuit 530 to enter the power down mode or the power saving mode (i.e. any operation mode with lower power consumption). The control signal may be received by the timing control circuit 522 from the front-end system circuit 510 and then output to the source driver circuit 530 or alternatively, may be generated by the timing control circuit 522 when detecting that the image signal is masked. In other embodiments, the timing control circuit 522 may not have to control the source driver circuit 530 to enter to the power down mode or the power saving mode without generating a control signal, but instead, the source driver circuit 530 itself enters the power down mode or the power saving mode when detecting the masked image signal of the output signal Sout.

In different embodiments, whether the input signal Sin corresponds to a static image may be determined by the front-end system circuit 510 or self-determined by the timing control circuit 522. Moreover, in different embodiments, the operation of masking the image signal of the output signal Sout may be performed by the front-end system circuit 510 or by the timing control circuit 522. In the meantime, the input signal Sin may select to be temporarily stored in the timing control circuit 522, depending on whether a frame buffer is configured or used in the internal configuration of the timing control circuit 522. Accordingly, the configuration varies with the design requirements. Besides, in some embodiments, the timing control circuit 522 may be configured to be operated in one or more modes, and what apparatus to perform the determination, and/or what apparatus to mask, and/or whether to configure or use a frame buffer depend on what mode the timing control circuit 522 operates in.

In a specific embodiment, the timing control circuit 522 operates in at least one of the following four modes including a panel self refresh (PRS) mode, a normal determination mode, a frame buffer determination mode and a system determination mode. Herein, the terminology for the modes is only for purpose of explanation rather than limitation.

In the PSR mode, the front-end system circuit 510 determines whether the image signal corresponds to a static image so as to according to a determination result, determine whether to control the timing control circuit 522 to mask the image signal. In detail, when determining that the image signal corresponds to a static image, the front-end system circuit 510 instructs the timing control circuit 522 to first temporarily stores one or more frame data (e.g. the last frame data) of the image signal after receiving the input signal Sin and then to perform the masking operation. In an exemplary embodiment, one or more frame partially-masked periods may be arranged in a period when the image signal corresponds to a static image. The timing control circuit 522 may generate frame data of the image signal of the output signal Sout during the first time interval of the frame partially-masked period. In addition, during the second time interval of the frame partially-masked period, the timing control circuit 522 masks the image signal and does not use the received frame data of the image signal of the input signal Sout to output the frame data of the image signal of the output signal Sout.

Additionally, in an exemplary embodiment, but not limited to, during the second time interval, one of or both the timing control circuit 522 and the source driver circuit 530 may enter the power down mode or the power saving mode (i.e. any operation mode with lower power consumption).

In an exemplary embodiment, one or more frame partially-masked periods may be arranged in a period when a static image is generated, and a plurality of frame partially-masked periods may be consecutively configured, such that outputting and not outputting the frame data may be periodically alternated with each other. For instance, the configuration may be outputting N frame data and not outputting M frame data (during a frame partially-masked period), outputting N frame data and not outputting M frame data (during the next frame partially-masked period) and so on.

Otherwise, when determining that the image signal corresponds to a dynamic image, the front-end system circuit 510 controls the timing control circuit 522 to be normally operated. That is, the front-end system circuit 510 does not mask the image signal but generates the image signal of the output signal Sout directly according to the image signal of the input signal Sin.

In addition, it should be noticed that after the determination of the static image by the front-end system circuit 510 and the notification to the timing control circuit 522 of performing the temporarily storing or during the entire time of each of the frame partially-masked periods, the front-end system circuit 510 may stop generating the image signal of the input signal Sin and even further enter the power down mode and the power saving mode (i.e. any operation mode with lower power consumption). Moreover, in this mode, the timing control circuit 522 may be configured with a frame buffer to temporarily store the frame data.

In the normal determination mode, the timing control circuit 522 self-determines whether the image corresponding to the input signal Sin is a static image so as to determine whether to mask the image signal according to a determination result. In other words, differing from the PSR mode, in this mode, no matter whether the image corresponding to the input signal Sin is a static image, the front-end system circuit 510 does not have to mask the image signal of the input signal Sin but normally outputs the image signal of the input signal Sin to the timing control circuit 522. Additionally, after receiving the input signal Sin, the timing control circuit 522 does not temporarily store and generates the output signal Sout directly according to the one or more frame data of the image signal of the input signal Sout.

To be more detailed, when determining that the image signal corresponds to the static image, the timing control circuit 522 masks the image signal directly according to the received frame data of the image signal of the input signal Sin. In an exemplary embodiment, one or more frame partially-masked periods may be arranged in a period when the image signal corresponds to a static image. During the first time interval of the frame partially-masked period, the timing control circuit 522 generates frame data of the image signal of the output signal Sout according to the received frame data of the image signal of the input signal Sout. Moreover, during the second time interval of the frame partially-masked period, the timing control circuit 522 masks the image signal and does not use the received frame data of the image signal of the input signal Sout to output the frame data of the image signal of the output signal Sout.

Additionally, in an exemplary embodiment, but not limited to, during the second time interval, one of or both timing control circuit 522 and the source driver circuit 530 may enter the power down mode or the power saving mode (i.e. any operation mode with lower power consumption).

In an exemplary embodiment, one or more frame partially-masked periods may be arranged in a period of generating a static image, and a plurality of frame partially-masked periods may be consecutively configured, such that outputting and not outputting the frame data may be periodically alternated with each other. For instance, the configuration may be outputting N frame data and not outputting M frame data (during a frame partially-masked period), outputting N frame data and not outputting M frame data (during the next frame partially-masked period) and so on.

On the contrary, when determining that the image signal corresponds to a dynamic image, the timing control circuit 522 is normally operated and namely, does not mask the image signal but generates the image signal of the output signal Sout directly according to the image signal of the input signal Sin. In this mode, the timing control circuit 522 may configured with an image determination unit to determine whether the image signal is in a static state. In some embodiments where the timing control circuit 522 requires to be operated only in this mode, the configuration of the frame buffer may be omitted.

In the frame buffer determination mode, as similar to the normal determination mode, the timing control circuit 522 self-determines whether the image corresponding to the input signal is a static image and determines whether to mask the image signal according to a determination result. In addition, no matter whether the image corresponding to the input signal Sin is a static image, the front-end system circuit 510 does not mask but instead outputs the image signal of the input signal Sin to the timing control circuit 522 normally. Differing from the normal determination mode, when determining that the image signal corresponds to the static image, the timing control circuit 522 temporarily stores one or more frame data (e.g. the last frame data) of the image signal and then performs the masking operation after receiving the input signal Sin.

In an exemplary embodiment, one or more frame partially-masked periods may be arranged in a period when the image signal corresponds to a static image. During the second time interval of the frame partially-masked period, the timing control circuit 522 generates frame data of the image signal of the output signal Sout according to the temporarily stored frame data. Besides, during the second time interval of the frame partially-masked period, the timing control circuit 522 masks the image signal and does not use frame data of the received image signal of the input signal Sout to output the frame of the image signal of the output signal Sout.

Additionally, in an exemplary embodiment, but not limited to, during the second time interval, one of or both timing control circuit 522 and the source driver circuit 530 may enter the power down mode or the power saving mode (i.e. any operation mode with lower power consumption).

In an exemplary embodiment, one or more frame partially-masked periods may be arranged in a period of generating a static image, and a plurality of frame partially-masked periods may be consecutively configured, such that outputting and not outputting the frame data may be periodically alternated with each other. For instance, the configuration may be outputting N frame data and not outputting M frame data (during a frame partially-masked period), outputting N frame data and not outputting M frame data (during the next frame partially-masked period) and so on. Otherwise, when determining that the image signal corresponds to a dynamic image, the timing control circuit 522 is normally operated and namely, does not mask the image signal but generates the image signal of the output signal Sout directly according to the image signal of the input signal Sin. Moreover, in this mode, the timing control circuit 522 may be configured with a frame buffer and an image determination unit to temporarily store the frame data and determine whether the image signal is in a static state, respectively.

In the system determination mode, the front-end system circuit 510 determines whether the image signal corresponds to a static image so as to determine whether to mask the image signal according to a determination result. In other words, as the same as in the panel self refresh mode, whether the image signal corresponds to a static image is determined by the front-end system circuit 510, and the masking operation is performed by the front-end system circuit 510 instead of the timing control circuit 522. Further, after receiving the input signal Sin, the timing control circuit 522 does not temporarily store the one ore more frame data of the image signal of the input signal Sout but instead generates the output signal Sout directly according thereto. To be more detailed, when determining that the image signal corresponds to a static image, the front-end system circuit 510 generates and provides the masked image signal of the input signal Sin the same to the timing control circuit 522. In an exemplary embodiment, one or more frame partially-masked periods may be arranged in a period when the image signal corresponds to a static image. During the first time interval of the frame partially-masked period, the front-end system circuit 510 does not mask the image signal but outputs frame data of the image signal of the input signal Sin. Thus, the timing control circuit 522 may generate frame data of the image signal of the output signal Sout directly according to the received frame data of the image signal of the input signal Sout. Moreover, during the second time interval of the frame partially-masked period, the front-end system circuit 510 masks the image signal but does not output the frame data of the image signal of the input signal Sin. Thus, the timing control circuit 522 does not output the frame data of the image signal of the output signal Sout, likewise.

Additionally, in an exemplary embodiment, but not limited to, during the second time interval, one of or both timing control circuit 522 and the source driver circuit 530 may enter the power down mode or the power saving mode (i.e. any operation mode with lower power consumption).

In an exemplary embodiment, during a period when a static image is generated, one or more frame partially-masked periods may be arranged, and a plurality of frame partially-masked period may be consecutively configured, such that outputting and not outputting the frame data may be periodically alternated with each other. For instance, the configuration may be outputting N frame data and not outputting M frame data (during a frame partially-masked period), outputting N frame data and not outputting M frame data (during the next frame partially-masked period) and so on.

On the contrary, when determining that the image signal corresponds to a dynamic image, the front-end system circuit 510 is normally operated, and namely, does not mask the image but and normally generates the image signal of the input signal Sin. In some embodiments where the timing control circuit 522 requires to be operated only in this mode, the configuration of the frame buffer may be omitted.

Furthermore, detailed operation of the internal circuit of the timing control circuit of the disclosure when being operated in the different modes will be described by illustrating some embodiments.

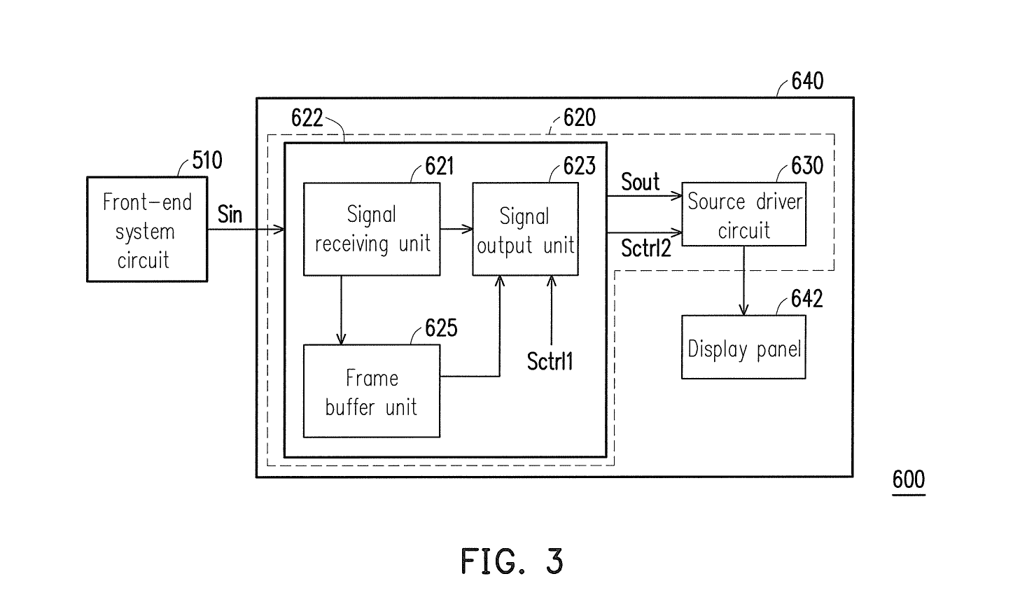

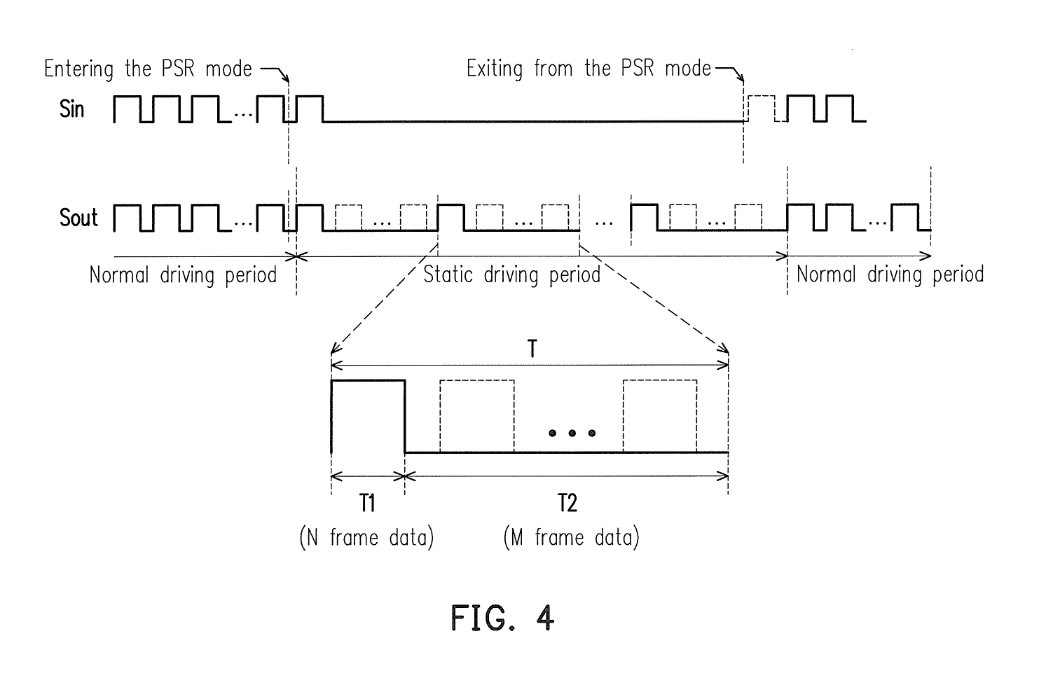

FIG. 3 is a schematic diagram illustrating the internal configuration of a timing control circuit according to an exemplary embodiment of the disclosure. FIG. 4 illustrates schematic waveforms of the input signal and the output signal depicted in FIG. 3. Referring to FIG. 3 and FIG. 4, a timing control circuit 622 of the present exemplary embodiment operates in, for example, a PSR mode. In the present exemplary embodiment, the timing control circuit 622 includes a signal receiving unit 621, a signal output unit 623 and a frame buffer unit 625. The frame buffer unit 625 is coupled between the signal receiving unit 621 and the signal output unit 623 and configured to receive and store frame data of an image signal of the input signal Sin so as to provide the same to the signal output unit 623.

During a normal driving period, an image signal input to the timing control circuit 622 may correspond to, for example, a dynamic image. At this time, the input signal Sin and the output signal Sout of the timing control circuit 622 are operated in the same frame rate, such as 60 Hz, and currently, the image display system does not mask the frame data of the image signal yet.

Otherwise, when the image display system detect that content of a displayed image is the same (i.e. a static image), or a required response time is slower, for example, the system operates in a text mode, the timing control circuit 622 instructs the timing control circuit 622 to temporarily store the frame data of the image signal of the input signal Sin and enter the static driving period. It should be noticed that the front-end system circuit 510 does not have to perform the masking operation on the image signal of the input signal Sin.

During the static driving period, or the entire frame partially-masked period, the frame data of the image signal is temporarily stored by the timing control circuit 622, and thus, the front-end system circuit 510 of the timing control circuit 622 does not have to continue to output the frame data to the timing control circuit 622. At this time, the front-end system circuit 510 may selectively determine whether to enter the power down mode, and if yes, the front-end system circuit 510 does not output the input signal Sin to the timing control circuit 622 after entering the power down mode.

During the static driving period, after receiving the input signal Sin, the signal receiving unit 621 first temporarily stores one or more frame data (e.g. the last frame data) of the image signal in the frame buffer unit 625. Then, the signal output unit 623 generates the output signal Sout according to the one or more temporarily stored frame data. In the present exemplary embodiment, the masking operation on the image signal of the output signal Sout is performed by the signal output unit 623. To be more specific, a static driving period may include one or more frame partially-masked periods, and each of the frame partially-masked periods includes a first time interval and a second time interval. During the first time interval, the signal output unit 623 outputs the image signal according to the one or more temporarily stored frame data. During the second time interval, the signal output unit 623 receives an instruction signal Sctrl1 so as to mask but not to output the image signal.

In an exemplary embodiment, a period when the image signal corresponds to a static image includes one ore more frame partially-masked periods T. During a first time interval T1 of the frame partially-masked period T, which is referred to as an active interval, the signal output unit 623 uses the one or more temporarily stored frame data to output N frame data of the image signal. During a second time interval T2 of the frame partially-masked period T, which is referred to as a power down interval, the signal output unit 623 does not output M frame data of the image signal. M and N are positive integers. Referring to FIG. 4, the illustrated active interval T1 includes one frame data, i.e. N=1, of which the number is only used for illustration, rather than constructs limitations to the disclosure. In the present exemplary embodiment, the signal output unit 623 may adjust the number of the frame data, i.e. numbers of M and N or a ratio of M to N, according to actual design requirements, such as features of a panel.

In the present exemplary embodiment, the frame data illustrated in FIG. 4 has a fixed voltage level during the power down interval T2, which is merely used to describe that the signal output unit 623 stops to outputting frame data instead of indicating that the display panel 642 displays a black screen. In addition, during the power down interval T2, the timing control circuit 622, for example, may enter the power down mode or the power saving mode. After entering the power down mode or the power saving mode, at least one circuit block in the internal configuration of the timing control circuit 622 that does not require to be operated may be turned off so as to achieve power down or power saving. Moreover, during the power down interval T2, the timing control circuit 622 may output a control signal Sctrl2 to control the source driver circuit 630 to enter the power down mode or the power saving mode. After entering the power down mode or the power saving mode, at least one circuit block in the internal configuration of the source driver circuit 630 that does not require to be operated may be turned off so as to achieve power down or power saving.

It should be noticed that in some embodiments, after receiving the input signal Sin, the signal receiving unit 621 performs the temporarily storing operation only when the image signal corresponds to the static image. However, in other embodiments, after receiving the input signal Sin, the signal receiving unit 621 may also directly temporarily store the input signal Sin in the frame buffer unit 625, and namely, the temporarily storing operation is not necessary to be performed only when the image signal corresponds to the static image, and/or the signal output unit may generate the output signal Sout by reading the frame data temporarily stored in the frame buffer unit 625.

In an exemplary embodiment, during the static driving period, the front-end system circuit 510 may also reduce frame rates of the input signal Sin and the output signal Sout synchronously, for example, from 60 Hz down to 40 Hz, so as to achieve power down. In other words, during each frame partially-masked period T, the frame rate of the image signal is adjusted to be lower than that of the image signal corresponding to a dynamic image.

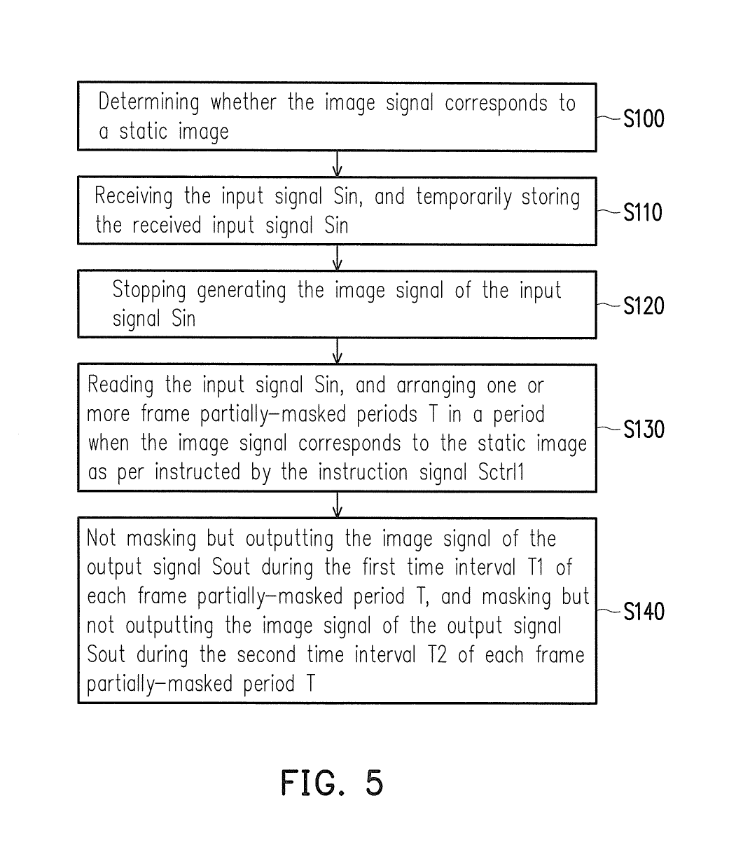

FIG. 5 is a flowchart illustrating a display driving method according to an exemplary embodiment of the disclosure. Referring to FIG. 5 with FIG. 3, the image display system operates in the PSR mode, and the display driving method in this mode includes the following steps. In step S100, the front-end system circuit 510 first determines whether the image signal corresponds to a static image. If yes, in step S110, the signal receiving unit 621 receives the input signal Sin and temporarily stores the received input signal Sin in the frame buffer unit 625. At this time, the front-end system circuit 510 may further stop generating the image signal of the input signal Sin, as shown in step S120. Then, in step S130, the signal output unit 623 reads the input signal Sin from the frame buffer unit 625 and as per instructed by the instruction signal Sctrl1, arranges one or more frame partially-masked periods T in a period when the image signal corresponds to a static image. Thereafter, in step S140, during the first time interval T1 of each frame partially-masked period T, the signal output unit 623 does not mask but outputs the image signal of the output signal Sout, and during the second time interval T2 of each frame partially-masked period T, the signal output unit 623 masks but does not output the image signal of the output signal Sout. Accordingly, when step S140 is completed, a part of frame data of the image signal of the output signal Sout is masked.

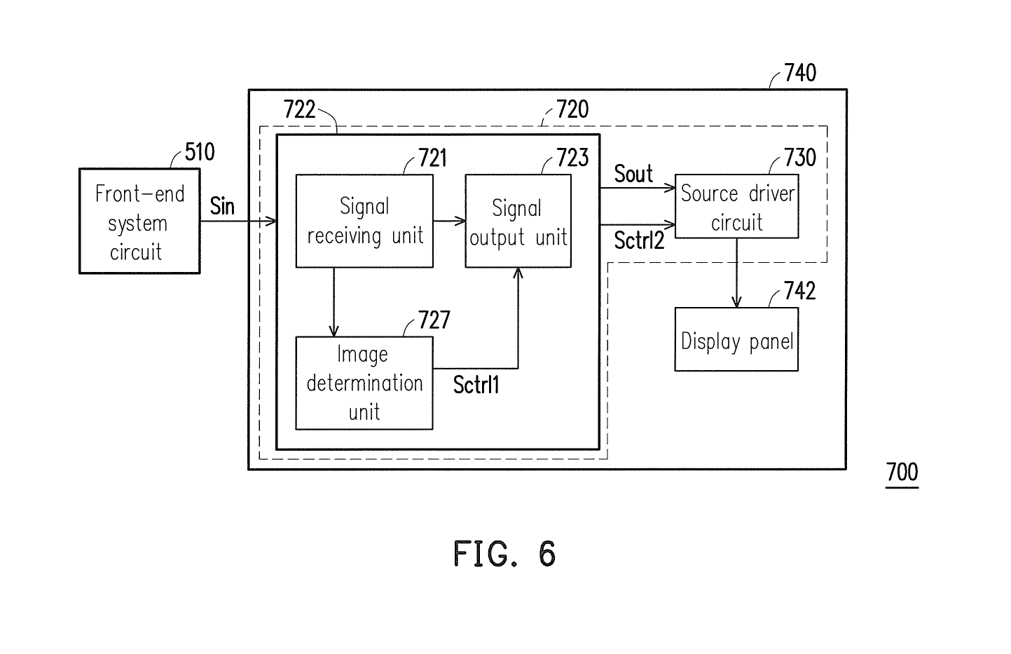

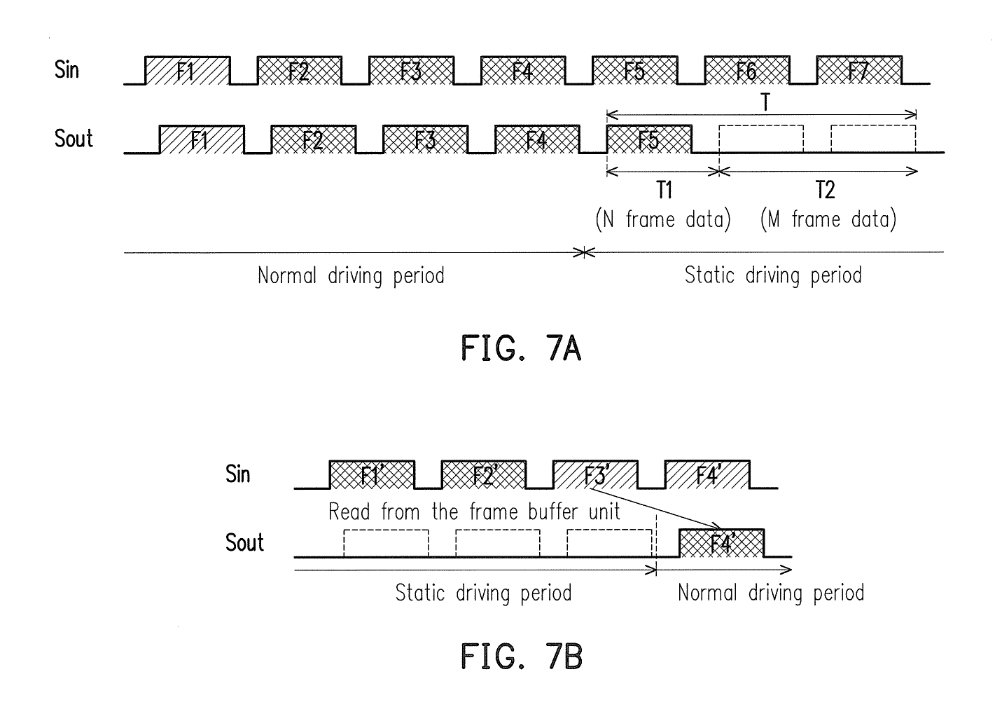

FIG. 6 is a schematic diagram illustrating the internal configuration of a timing control circuit according to another exemplary embodiment of the disclosure. FIG. 7A and FIG. 7B respectively illustrate schematic waveforms of the input signal and the output signal depicted in FIG. 6 when entering a static driving period and exiting from the static driving period. Referring to FIG. 6, FIG. 7A and FIG. 7B, in the present exemplary embodiment, a timing control circuit 722 operates in, for example, the normal determination mode and includes a signal receiving unit 721, a signal output unit 723 and an image determination unit 727. The image determination unit 727 is coupled to the signal receiving unit 721 and configured to determine whether an image corresponding to the input signal Sin is a static image. If yes, the image determination unit 727 generates the instruction signal Sctrl1 to instruct the signal output unit 723 to enter the static driving period to mask the image signal.

In particular, in the present exemplary embodiment, if the image determination unit 727 determines that the image corresponding to the input signal Sin is a static image, the timing control circuit 722 enters the static driving period. In the present exemplary embodiment, the image determination unit 727 determines whether the image signal corresponds to a static image according to, for example, cyclic redundancy check (CRC) of a plurality of frame data of the image signal. For example, referring to FIG. 7A, when determining that CRCs of frame data F1 through F4 of the image signal are the same, the timing control circuit 722 enters the static driving period. During this period, the image determination unit 727 outputs the instruction signal Sctrl1 to the signal output unit 723 to instruct the signal output unit 723 to mask the image signal. To be more specific, the static driving period may includes one or more frame partially-masked periods, and each includes a first time interval and a second time interval. During the first time interval of the frame partially-masked period of the static driving period, the signal output unit 723 uses the frame data received from the signal receiving unit 721 to generate and output the image signal. During the second time interval, the signal output unit 623 receives the instruction signal Sctrl1 but not use the frame data received from the signal receiving unit 721 to generate and output the frame data of the image signal of the output signal Sout, which may refer to the output signal Sout illustrated in FIG. 7A.

It should be noticed that in the present exemplary embodiment, the front-end system circuit Sin does not perform the masking operation, and thus, during the entire time of the frame partially-masked period T, which includes the first time interval (i.e. the active interval) T1 and the second time interval (i.e. the power down interval) T2, the image signal of the input signal Sin is not masked. In addition, in the present exemplary embodiment, no frame buffer for storing the frame data does not require to be configured or used in the internal configuration of the timing control circuit 722, and namely, the signal output unit 723 is directly connected to the signal receiving unit 721 so as to receive at least one frame data of the image signal of the input signal Sin and generate the output signal Sout according to the at least one frame data.

During the static driving period, the image determination unit 727 continues to determine whether the CRCs of the frame data of the image signal are the same. If not, for example, CRCs of frame data F3′ and F4′ illustrated in FIG. 7B are different, the image determination unit 727 controls the signal output unit 723 to stop the masking operation on the image signal. At this time, the timing control circuit 722 exits from the static driving period and returns to the normal driving period.

Similar to the PSR mode, in the present exemplary embodiment, during the power down interval T2, i.e. when the signal output unit 723 masks the image signal of the output signal Sout, the timing control circuit 722 may, for example, enter the power down mode or the power saving mode. After entering the power down mode or the power saving mode, at least one circuit block in the internal configuration of the timing control circuit 722 that does not require to be operated may be turned off so as to achieve power down or power saving. In addition, during the power down interval T2, the signal output unit 723, for example, outputs the control signal Sctrl2 to control the source driver circuit 730 to enter the power down mode or the power saving mode. After entering the power down mode or the power saving mode, at least one circuit block in the internal configuration of the source driver circuit 730 that does not require to be operated may be turned off so as to achieve power down or power saving.

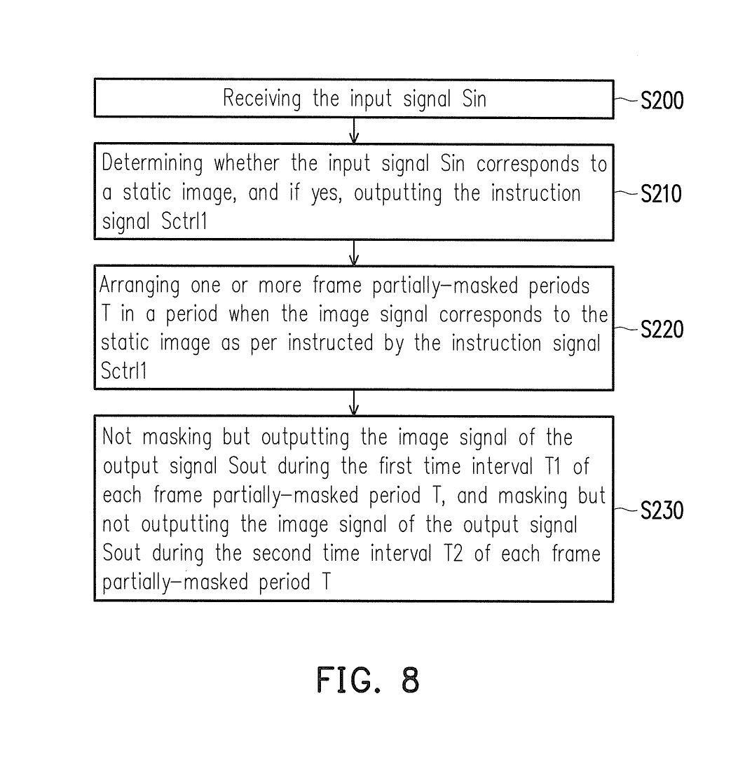

FIG. 8 is a flowchart illustrating a display driving method according to another exemplary embodiment of the disclosure. Referring to FIG. 8 with FIG. 6, in the present exemplary embodiment, the image display system operates in the normal determination mode, where the display driving method includes the following steps. In step S200, the signal receiving unit 721 first receives the input signal Sin and transmits the input signal Sin to the image determination unit 727. Then, in step S210, the image determination unit 727 determines whether the input signal Sin corresponds to a static image. If yes, the instruction signal Sctrl1 is output to the signal output unit 723. Then, in step S220, the signal output unit 723 is instructed by the instruction signal Sctrl1 to arrange one or more frame partially-masked periods T in a period when the image signal corresponds to the static image. Thereafter, in step S230, during the first time interval T1 of each frame partially-masked period T, the signal output unit 723 does not mask but outputs the image signal of the output signal Sout and during the second time interval T2 of each frame partially-masked period T, masks but does not output the image signal of the output signal Sout. Thus, when step S240 is completed, a part of frame data of the image signal of the output signal Sout is masked.

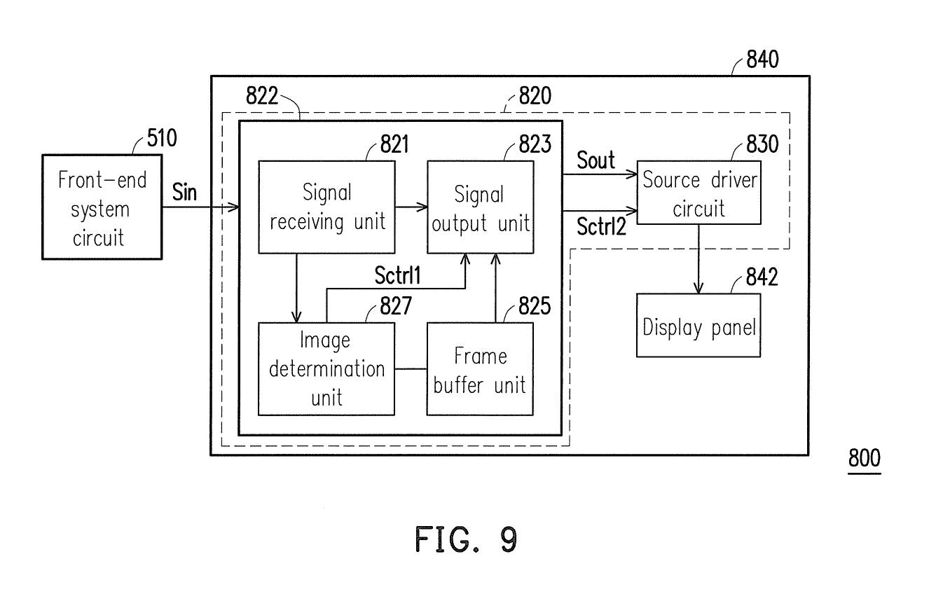

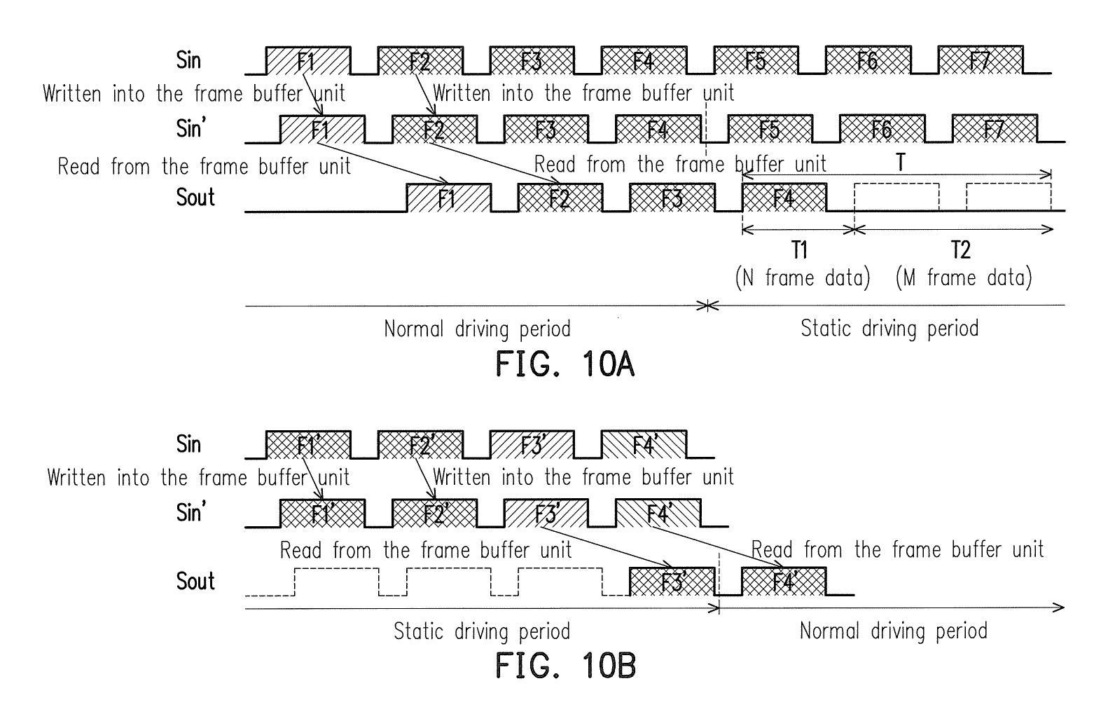

FIG. 9 is a schematic diagram illustrating the internal configuration of a timing control circuit according to still another exemplary embodiment of the disclosure. FIG. 10A and FIG. 10B respectively illustrate schematic waveforms of the input signal and the output signal depicted in FIG. 9 when entering a static driving period and exiting from the static driving period. Referring to FIG. 9, FIG. 10A and FIG. 10B, in the present exemplary embodiment, a timing control circuit 822 operates in, for example, the frame buffer determination mode, and the internal structure of the timing control circuit 822 is similar to the timing control circuit 722 illustrated in FIG. 6; however, the timing control circuit 822 further includes a frame buffer unit 825 configured to temporarily store frame data of the image signal of the input signal Sin.

In the present exemplary embodiment, similar to the normal determination mode, whether the image signal corresponds to a static image is also determined by an image determination unit 827. After receiving the input signal Sin, a signal receiving unit 821 transmits the input signal Sin to the image determination unit 827 for an image determination operation. If determining as a static image, a signal receiving unit 821 temporarily stores at least one frame data (e.g. the last frame data) of the input signal Sin in the frame buffer unit 825, and the timing control circuit 822 enters the static driving period. During the static driving period, a signal output unit 823 reads the temporarily stored frame data from the frame buffer unit 825 and is instructed by the instruction signal Sctrl1 to mask the frame data during a power down interval T2. To be more specific, the static driving period may include one ore more frame partially-masked periods, and each includes a first time interval and a second time interval. During the first time interval of the frame partially-masked period of the static driving period, the signal output unit 823 uses the frame data received from the frame buffer unit 825 to generate and output the image signal while during the second time interval, the signal output unit 823 receives the instruction signal Sctrl1 and does not output (but masks) the frame data of the image signal of the output signal Sout.

It should be noticed that in some embodiments, after receiving the input signal Sin, the signal receiving unit 821 performs the temporarily storing operation only when the image signal corresponds to a static image. However, in other embodiments, after receiving the input signal Sin, the signal receiving unit 821 may also directly temporarily store the input signal Sin in the frame buffer unit 825, without a static image detected. Moreover, in such embodiments, the image determination unit 827 may perform the image determination operation by reading the temporarily stored frame data from the frame buffer unit 825, and/or the signal output unit may generate the output signal Sout by reading the temporarily stored frame data from the frame buffer unit 825.

Similar to the PSR mode and the normal determination mode, during the power down interval T2, i.e. when the signal output unit 823 masks the image signal of the output signal Sout, the timing control circuit 822, for example, enters the power down mode or the power saving mode. After entering the power down mode or the power saving mode, at least one circuit block in the internal configuration of the timing control circuit 822 that does not require to be operated may be turned off so as to achieve power down or power saving. Moreover, during the power down interval T2, the signal output unit 823, for example, outputs the control signal Sctrl2 to control the source driver circuit 830 to enter the power down mode or the power saving mode. After entering the power down mode or the power saving mode, at least one circuit block in the internal configuration of the source driver circuit 830 that does not require to be operated may be turned off so as to achieve power down or power saving.

As illustrated in FIG. 10A and FIG. 10B, the frame data of the image signal of the input signal Sin is temporarily stored in frame buffer unit 825 and represented by Sin′. First, referring to FIG. 10A, before entering the static driving period, the input signal Sin is sequentially written into the frame buffer unit 825, and then, the temporarily stored frame data is sequentially read from the frame buffer unit 825 by the signal output unit 823 so as to generate the output signal Sout. Thus, in the signal timing sequence, the output signal Sout is delayed for a frame period compared to the input signal Sin. After entering the static driving period, the frame data F4 of the output signal Sout is configured as initial frame data of the frame partially-masked period, which is not masked. In this case, the signal output unit 823 masks the frame data F5 and F6 of the output signal Sout during the power down interval. With further reference to FIG. 10B, before the static driving period is completed, the frame data F3′ is read from the frame buffer unit 825 by the signal output unit 823 and configured as an end frame data of the static driving period to continue with the initial frame data F4′ in the normal driving period so as to avoid discontinuousness of the frame data.

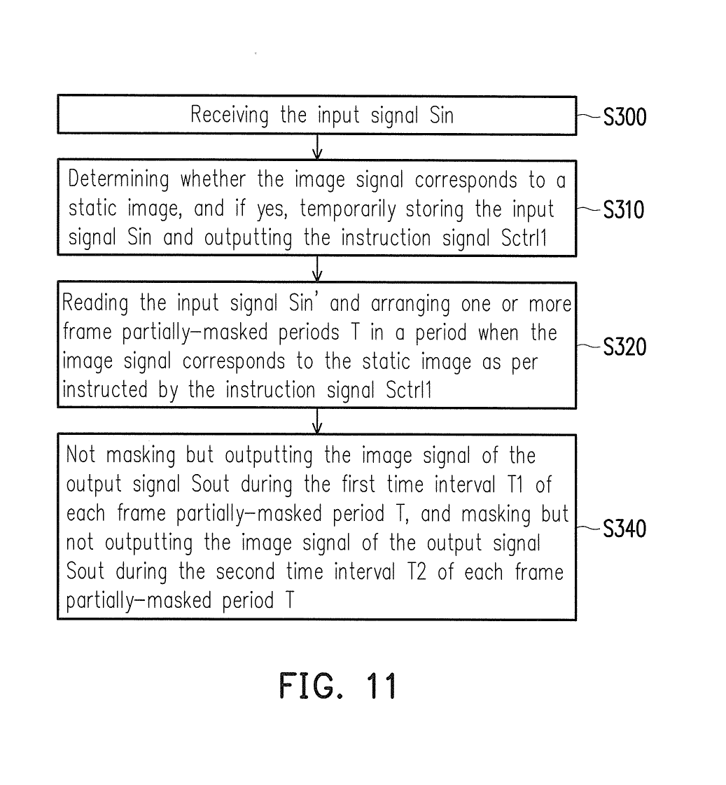

FIG. 11 is a flowchart illustrating a display driving method according to still another exemplary embodiment of the disclosure. Referring to FIG. 11 with FIG. 9, in the present exemplary embodiment, the image display system operates in the frame buffer determination mode and the display driving method includes the following steps. In step S300, the signal receiving unit 821 first receives the input signal Sin and transmits it to the image determination unit 827. Then, in step S310, the image determination unit 827 determines again whether the image signal corresponds to a static image. If yes, the signal receiving unit 821 is instructed to temporarily store the input signal Sin in the frame buffer unit 825, and the instruction signal Sctrl1 is output to the signal output unit 823. Then, in step S320, the signal output unit 823 reads an input signal Sin′ from the frame buffer unit 825 and is instructed by the instruction signal Sctrl1 to arrange one or more frame partially-masked periods T in a period when the image signal corresponds to a static image. Thereafter, in step S340, during the first time interval T1 of each frame partially-masked period T, the signal output unit 823 does not and outputs the image signal of the output signal Sout, and during the second time interval T2 of each frame partially-masked period T masks but does not output the image signal of the output signal Sout. Thus, when step S340 is completed, a part of the frame data of the image signal of the output signal Sout is masked.

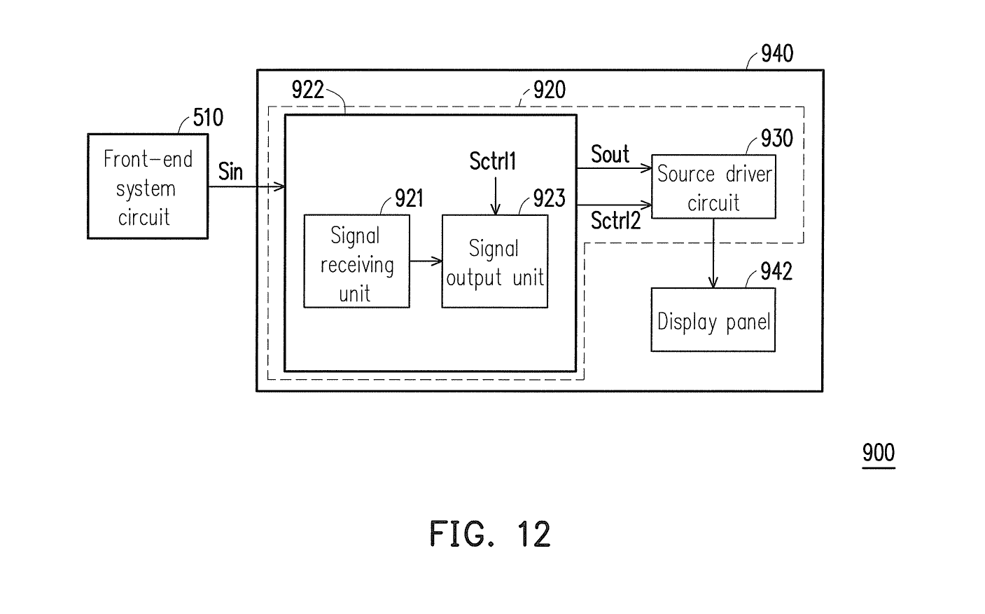

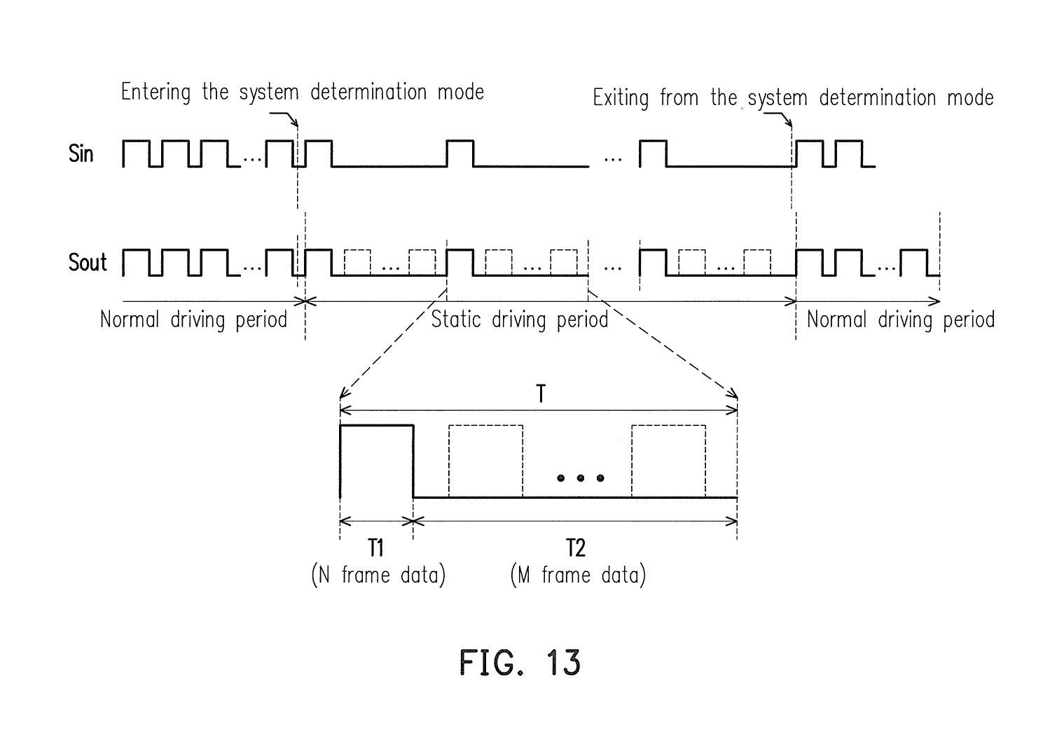

FIG. 12 is a schematic diagram illustrating the internal configuration of a timing control circuit according to yet another exemplary embodiment of the disclosure. FIG. 13 illustrates schematic waveforms of the input signal and the output signal depicted in FIG. 12. Referring to FIG. 13 and FIG. 12, in the present exemplary embodiment, a timing control circuit 922 operates, for example, in the system determination mode. The timing control circuit 922 includes a signal receiving unit 921 and a signal output unit 923. The signal output unit 923 may be directly connected to the signal receiving unit 921 to directly receive at least one frame data of the image signal of the input signal Sin and generate an output signal according to the at least one frame data.

In detail, in the present exemplary embodiment, whether the image signal corresponds to a static image is determined by the front-end system circuit 510, and the masking operation on the image signal of the output signal Sout is also operated by the front-end system circuit 510 to first mask the image signal of the input signal Sin before the input signal Sin is input to the signal receiving unit 921. When the masking operation is performed, the front-end system circuit 510 does not generate nor provide the image signal of the input signal Sin to the signal receiving unit 921. Otherwise, when the masking operation is not performed, the front-end system circuit 510 generates and provides the image signal of the input signal Sin to the signal receiving unit 921.

In an exemplary embodiment, one or more frame partially-masked periods may be arranged in a period when the input signal Sin corresponds to a static image, and each frame partially-masked period T includes a first time interval and a second time interval. As illustrated in FIG. 13, during the first time interval T1, the image signal of the input signal Sin (including N frame data) is not masked by the front-end system circuit 510 but received by the signal receiving unit 921. On the other hand, during the second time interval T2, the image signal of the input signal Sin (including M frame data) is masked by the front-end system circuit 510 but not received by the signal receiving unit 921. Moreover, during the second time interval (i.e. the power down interval) T2, the signal output unit 923 does not output frame data to the source driver circuit 930, but still may output the control signal Sctrl2 to the source driver circuit 930 to control the source driver circuit 930 to enter the power down mode/power saving mode. Corresponding to the input signal Sin, the output signal Sout of the timing control circuit 922 also has one or more frame partially-masked periods.

In an exemplary embodiment, when the image signal of the input signal Sin is masked, the signal output unit 923, even the entire timing control circuit 922 may be further controlled to enter the power down mode. Moreover, in such embodiments, when the signal output unit 923 is controlled by the instruction signal Sctrl1 and enters the power down mode, the source driver circuit 930 may also enters the power down or power saving mode. In other words, at least one circuit block in the internal configuration of one of the timing control circuit 922 and the source driver circuit 930 that does not require to be operated may be turned off so as to achieve power down or power saving. In the meantime, the control signal Sctrl1 may be embedded in the image signal or provided by the front-end system circuit 510.

On the other hand, in some embodiments, in the system determination mode, the front-end system circuit 510 operates in a power on mode during the first time interval, i.e. when the front-end system circuit 510 outputs the image signal of the input signal Sin and the front-end system circuit 510 may be operated in the power down mode or the power saving mode does not output during the second time interval, i.e. when the front-end system circuit 510 does not output the image signal of the input signal Sin. However, the disclosure is not limited thereto. For instance, in other embodiments, no mater whether the front-end system circuit 510 generates the image signal of the input signal Sin, the front-end system circuit 510 operates in the power on mode.

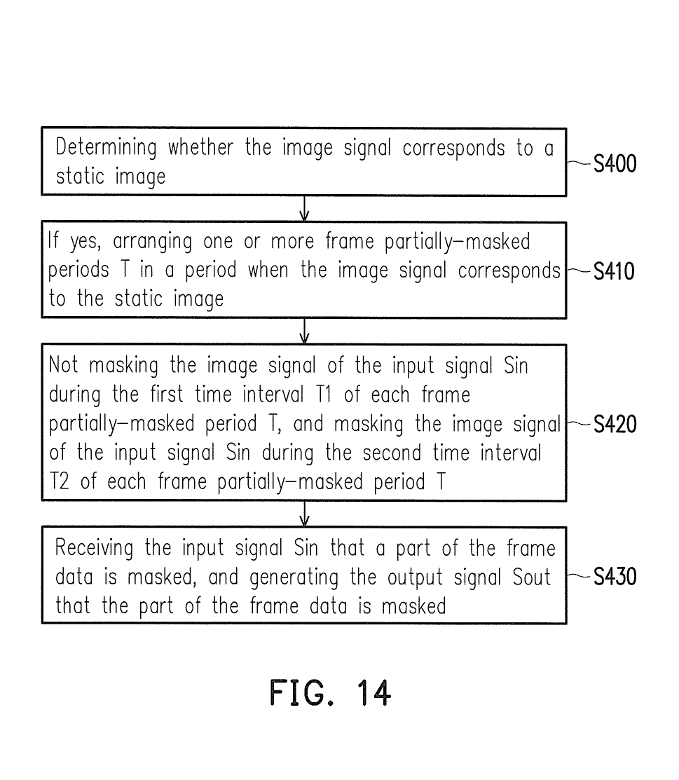

FIG. 14 is a flowchart illustrating a display driving method according to yet another exemplary embodiment of the disclosure. Referring to FIG. 14 with FIG. 12, in the present exemplary embodiment, the image display system operates in the system determination mode and the display driving method includes the following steps. In step S400, the front-end system circuit 510 first determines whether the image signal corresponds to a static image. If yes, in step S410, the front-end system circuit 510 arranges one or more frame partially-masked periods T in a period when the image signal corresponds to a static image, and each frame partially-masked period T includes a first time interval and a second time interval. Then, in step S420, the front-end system circuit 510 does not mask the image signal of the input signal Sin during the first time interval T1 but masks the image signal of the input signal Sin during the second time interval T2. Thus, in step S430, the input signal Sin having a part of the frame data masked is received by the signal receiving unit 921. Corresponding to the input signal Sin, during the first time interval T1 of the frame partially-masked period T, the image signal of the output signal Sout is not masked but output, and during the second time interval T2, the image signal of the output signal Sout is masked but not output. (It should be noticed that there may be a time difference between the time of the input signal Sin being masked and the time of the output signal Sout being masked, which to be in brief, are represented by the same symbols T, T1 and T2). Thus, when step S430 is completed, the output signal Sout with a part of frame data masked is generated by the signal output unit 923.

It should be noticed that even though the structures illustrated in FIG. 3, FIG. 6, FIG. 9 and FIG. 12 correspond to different modes, the same structure adapted to one or more modes may be adopted in an actual design. For instance, whether the structure illustrated in FIG. 9 may be adapted to the four modes depends on whether the image determination unit 827 may be used to perform the image determination and whether the frame buffer unit 825 is used to temporarily store the frame data.

Moreover, it should be noticed that in the above described embodiments, the image signal of the input/output signal is masked when the image signal corresponds to a static image in each of the modes. However, in other embodiments, not only the image signal of the input/output signal may be masked but also frame rates thereof may be reduced in each of the modes. Further, in still other embodiments, when the image signal corresponds to a static image, only the frame rates are reduced and the masking operation is not performed in each of the modes. As for the other operational details such as detection and determination operations, they all may refer to the masking operation, and will not be repeated for descriptive conciseness. In other words, all the scenarios where only the masking operation on the image signal of the input or output signal is performed, where only the reduction of the frame rates is performed or where both are performed fall within the scope of the disclosure.

In addition, it should be noticed that even though in each of the aforementioned embodiments, the first time interval T1 is arranged prior to the second time interval T2, in other embodiments, the first time interval T1 is arranged posterior to the second time interval T2. Moreover, each of the frame partially-masked periods may further include any other type and number of time intervals, which is not limited to including only the first and second time intervals. For example, a first through a N^{th} time intervals, i.e. T1 through TN (N is an integer greater than 1) may be included, wherein the output signal is masked and not masked alternatively, and other types of output signal may further arranged to be included therein. Further, in the aforementioned embodiments, a plurality of frame partially-masked period may be consecutively configured, such that outputting and not outputting the frame data may be periodically alternated with each other. However, in other embodiments, the above configuration may also be a periodically alternated with each other. Meanwhile, during the period of a static image or the static driving period, one or more the same frame partially-masked periods may be included, and one or more different frame partially-masked periods may also be included. Accordingly, various configurations with the output signal masked during a portion of the frame partially-masked periods and not masked during the other portion of frame partially-masked periods all fall within the scope of the disclosure. It is also noted that although in the above embodiments the frame partially masked period is arranged in a period when a static image is generated, in other embodiments, the frame partially masked period may be arranged in any operation other than a normal operation, if required, so as to save power consumption for example.

Based on the above, in the exemplary embodiments of the disclosure, the timing control circuit may be operated in different modes. Whether the input signal corresponds to a static image may be determined by the front-end system circuit or the timing control circuit. The masking operation on the image signal may be performed by the front-end system circuit or the timing control circuit. During the frame partially-masked period, the timing control circuit does not output (i.e., masks) a part of the frame data to the source driver circuit so as to achieve power down or power saving. Moreover, during the static driving period, the source driver circuit and/or the timing control circuit and/or the front-end system circuit may also be controlled to enter to the power down mode or the power saving mode. Also, the input signal may be temporarily stored in the timing control circuit or directly output after being processed by the signal output unit.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A timing control circuit, configured to drive a source driver circuit, the timing control circuit comprising:
a signal receiving unit, configured to receive an input signal, wherein the input signal comprises an image signal; and
a signal output unit, configured to generate an output signal according to the input signal, wherein the output signal comprises the image signal,
wherein a period when the image signal corresponds to a static image comprises one or more frame partially-masked periods, each of the frame partially-masked periods comprises a first time interval and a second time interval, the image signal of the output signal is not masked but output by the signal output unit during the first time interval, and the image signal of the output signal is masked but not output by the signal output unit during the second time interval.

2. The timing control circuit as claimed in claim 1, wherein the signal output unit outputs N frame data of the image signal during the first time interval of each of the frame partially-masked periods, and the signal output unit does not output M frame data of the image signal during the second time interval of each of the frame partially-masked periods, wherein M and N are positive integers.

3. The timing control circuit as claimed in claim 1, wherein the signal output unit further enters a power down mode or a power saving mode during the second time interval of each of the frame partially-masked periods.

4. The timing control circuit as claimed in claim 1, wherein the signal output unit further controls the source driver circuit to enter a power down mode or a power saving mode during the second time interval of each of the frame partially-masked periods.

5. The timing control circuit as claimed in claim 1, wherein generation of the image signal of the input signal is stopped, and the image signal of the input signal is not received by the signal receiving unit during the entire time of each of the frame partially-masked periods.

6. The timing control circuit as claimed in claim 1, wherein the image signal of the input signal is not masked but received by the signal receiving unit during the first time interval of each of the frame partially-masked periods, and the image signal of the input signal is masked but not received by the signal receiving unit during the second time interval of each of the frame partially-masked periods.

7. The timing control circuit as claimed in claim 1, wherein the image signal of the input signal received by the signal receiving unit is not masked during the entire time of each of the frame partially-masked periods.

8. The timing control circuit as claimed in claim 7, wherein the signal output unit masks the image signal during the second time interval of each of the frame partially-masked periods.

9. The timing control circuit as claimed in claim 8, further comprising:
an image determination unit, configured to determine whether an image corresponding to the input signal is the static image, and if yes, the image determination unit instructing the signal output unit not to mask the image signal during the first time interval of each of the frame partially-masked periods but mask the image signal during the second time interval of each of the frame partially-masked periods.

10. The timing control circuit as claimed in claim 9, wherein the image determination unit determines whether the image signal corresponds to the static image according to cyclic redundancy check (CRC) of a plurality of frame data of the image signal.

11. The timing control circuit as claimed in claim 1, further comprising:
a frame buffer unit, coupled between the signal receiving unit and the signal output unit and configured to receive and store at least one frame data of the image signal of the input signal so as to provide the at least one frame data to the signal output unit.

12. The timing control circuit as claimed in claim 1, wherein the signal output unit is directly connected to the signal receiving unit so as to directly receive at least one frame data of the image signal of the input signal and generate the output signal according to the at least one frame data.

13. The timing control circuit as claimed in claim 1, wherein the timing control circuit operates in at least one of the following four modes which comprise:
a panel self refresh (PRS) mode, wherein in the PRS mode, the timing control circuit comprises a frame buffer unit coupled between the signal receiving unit and the signal output unit, and the timing control circuit receives an external notification about whether an image corresponding to the input signal is the static image, the signal receiving unit temporarily stores at least one frame data of the image signal of the input signal in the frame buffer unit when the timing control circuit is notified that the image corresponding to the input signal is the static image, the signal output unit generates the output signal according to the at least one temporarily stored frame data during the first time interval of each of the frame partially-masked periods, and the signal output unit masks the image signal during the second time interval of each of the frame partially-masked period;
a normal determination mode, wherein in the normal determination mode, the signal output unit is directly connected to the signal receiving unit, the timing control circuit self-determines whether the image corresponding to the input signal is the static image, and the timing control circuit generates and outputs the output signal according to a determination result and by directly using the at least one frame data of the image signal of the input signal received from the signal receiving unit during the first time interval of each of the frame partially-masked periods, and the timing control circuit masks the image signal during the second time interval of each of the frame partially-masked periods;
a frame buffer determination mode, wherein in the frame buffer determination mode, the timing control circuit comprises a frame buffer unit coupled between the signal receiving unit and the signal output unit, and the timing control circuit self-determines whether the image corresponding to the input signal is the static image, the signal receiving unit temporarily stores the at least one frame data of the image signal of the input signal in the frame buffer unit when the static image is detected, the signal output unit generates the output signal according to the at least one temporarily stored frame data during the first time interval of each of the frame partially-masked periods, and the signal output unit masks the image signal during the second time interval of each of the frame partially-masked periods; and
a system determination mode, wherein in the system determination mode, the signal output unit is directly connected to the signal receiving unit, the image signal of the input signal is not masked and the signal output unit outputs the image signal of the output signal directly according to the image signal of the input signal during the first time interval of each of the frame partially-masked periods, and the image signal of the input signal is masked and the signal output unit does not output the image signal of the output signal in response to the masked input signal during the second time interval of the frame partially-masked periods.

14. The timing control circuit as claimed in claim 1, wherein a frame rate of the image signal is adjusted to be lower than that of the image signal corresponding to a dynamic image during each of the frame partially-masked periods.

15. An image driving apparatus, comprising:
a timing control circuit as claimed in claim 1; and
a source driver circuit, configured to be controlled by the timing control circuit to drive a display panel.

16. An image driving apparatus, configured to drive a display panel, the image driving apparatus comprising:
a timing control circuit, configured to receive an input signal and generates an output signal according to the input signal, wherein the input signal and the output signal comprise an image signal; and
at least one source driver circuit, each coupled to the timing control circuit and configured to receive the output signal and drive the display panel according to the output signal,
wherein a period when the image signal corresponds to a static image comprises one or more frame partially-masked periods, each of the frame partially-masked periods comprises a first time interval and a second time interval, the image signal of the output signal is not masked but output by the timing control circuit during the first time interval, and the image signal of the output signal is masked but not output by the timing control circuit during the second time interval.

17. The image driving apparatus as claimed in claim 16, wherein the timing control circuit outputs N frame data of the image signal during the first time interval of each of the frame partially-masked periods, and the timing control circuit does not output M frame data of the image signal of the output signal during the second time interval of each of the frame partially-masked periods, wherein M and N are positive integers.

18. The image driving apparatus as claimed in claim 16, wherein the timing control circuit further enters a power down mode or a power saving mode during the second time interval of each of the frame partially-masked periods.

19. The image driving apparatus as claimed in claim 16, wherein the timing control circuit further controls the source driver circuit to enter a power down mode or a power saving mode during the second time interval of each of the frame partially-masked periods.

20. The image driving apparatus as claimed in claim 16, wherein generation of the image signal of the input signal is stopped, and the image signal of the input signal is not received by the timing control circuit during the entire time of each of the frame partially-masked periods.

21. The image driving apparatus as claimed in claim 16, wherein the image signal of the input signal is not masked but received by the timing control circuit during the first time interval of each of the frame partially-masked periods, and the image signal of the input signal is masked but not received by the timing control circuit during the second time interval of the frame partially-masked period.

22. The image driving apparatus as claimed in claim 16, wherein the image signal of the input signal received by the timing control circuit is not masked during the entire time of each of the frame partially-masked periods.

23. The image driving apparatus as claimed in claim 22, wherein the timing control circuit masks the image signal during the second time interval of each of the frame partially-masked periods.

24. The image driving apparatus as claimed in claim 23, wherein the timing control circuit determines whether the image signal corresponds to the static image according to cyclic redundancy check (CRC) of a plurality of frame data of the image signal so as to determine whether to mask the image signal according to a determination result.

25. The image driving apparatus as claimed in claim 16, wherein after receiving the input signal, the timing control circuit temporarily stores one or more frame data of the image signal and generates the output signal according to the one or more temporarily stored frame data.

26. The image driving apparatus as claimed in claim 16, wherein after receiving the input signal, the timing control circuit does not temporarily store one or more frame data of the image signal but instead generates the output signal directly according to the one or more frame data of the image signal.

27. The image driving apparatus as claimed in claim 16, wherein the timing control circuit operates in at least one of the following four modes which comprise:
a panel self refresh (PSR) mode, wherein in the PSR mode, the timing control circuit receives an external notification about whether an image corresponding to the input signal is the static image, the timing control circuit temporarily stores at least one frame data of the image signal of the input signal when being notified that the image corresponding to the input signal is the static image, and the timing control circuit generates the output signal according to the at least one temporarily stored frame data during the first time interval of each of the frame partially-masked periods, and the timing control circuit masks the image signal during the second time interval of each of the frame partially-masked periods;
a normal determination mode, wherein in the normal determination mode, the timing control circuit self-determines whether the image corresponding to the input signal is the static image, the timing control circuit generates and outputs the output signal according to a determination result and by directly using the at least one frame data of the image signal of the received input signal during the first time interval of each of the frame partially-masked periods, and the timing control circuit masks the image signal during the second time interval of each of the frame partially-masked periods;
a frame buffer determination mode, wherein in the frame buffer determination mode, the timing control circuit self-determines whether the image corresponding to the input signal is the static image, the timing control circuit temporarily stores the at last one frame data of the image signal of the input signal when detecting the static image, the timing control circuit generates the output signal according to the at least one temporarily stored frame data during the first time interval of each of the frame partially-masked periods, and the timing control circuit masks the image signal during the second time interval of each of the frame partially-masked periods; and
a system determination mode, wherein in the system determination mode, the signal of the input signal is not masked and the timing control circuit outputs the image signal of the output signal directly according to the image signal of the input signal during the first time interval of each of the frame partially-masked periods, the image signal of the input signal is masked and the timing control circuit does not output the image signal of the output signal in response to the masked input signal during the second time interval of each of the frame partially-masked periods.

28. The image driving apparatus as claimed in claim 16, wherein a frame rate of the image signal is adjusted to be lower than that of the image signal corresponding to a dynamic image during each of the frame partially-masked periods.

29. An image display apparatus, comprising:
an image driving apparatus as claimed in claim 16; and
a display panel, configured to be driven by the image driving apparatus to display an image frame.

30. An image display system, comprising:
a front-end system circuit, configured to provide an input signal, wherein the input signal comprises an image signal;
a display driving apparatus, comprising:
a timing control circuit, coupled to the front-end system circuit and configured to receive the input signal and generate an output signal according to the input signal, wherein the output signal comprises the image signal, and a period when the image signal corresponds to a static image comprises one or more frame partially-masked periods, the image signal of the output signal is not masked but output by the timing control circuit during the first time interval, and the image signal of the output signal is masked but not output by the timing control circuit during the second time interval; and
at least one source driver circuit, coupled to the timing control circuit and configured to receive the output signal; and
a display panel, configured to be driven by the at least one source driver circuit to display an image frame, wherein the at least one source driver circuit drives the display panel according to the output signal.

31. The image display system as claimed in claim 30, wherein the timing control circuit outputs N frame data of the image signal during the first time interval of each of the frame partially-masked periods, and M frame data of the image signal is masked but not output by the timing control circuit during the second time interval of each of the frame partially-masked periods, wherein M and N are positive integers.

32. The image display system as claimed in claim 30, wherein the timing control circuit further enters a power down mode or a power saving mode during the second time interval of each of the frame partially-masked periods.

33. The image display system as claimed in claim 30, wherein the timing control circuit further controls the source driver circuit to enter a power down mode or a power saving mode during the second time interval of each of the frame partially-masked periods.

34. The image display system as claimed in claim 30, wherein the front-end system circuit determines whether the image signal corresponds to the static image, such that according to a determination result, the front-end system circuit instructs the timing control circuit not to mask the image signal and output the image signal of the output signal during the first time interval of each of the frame partially-masked periods, and the front-end system circuit instructs the timing control circuit to mask the image signal but not to output the image signal of the output signal during the second time interval of each of the frame partially-masked periods.

35. The image display system as claimed in claim 34, wherein the front-end system circuit further stops generating the image signal of the input signal during the entire time of each of the frame partially-masked periods.

36. The image display system as claimed in claim 35, wherein the front-end system circuit operates in a power down mode or a power saving mode when the front-end system circuit does not generate the image signal of the input signal.

37. The image display system as claimed in claim 30, wherein the front-end system circuit determines whether the image signal corresponds to the static image, such that according to a determination result, the front-end system circuit does not mask the image signal but outputs the image signal of the input signal during the first time interval of each of the frame partially-masked periods, and the front-end system circuit masks the image signal but does not output the image signal of the input signal during the second time interval of each of the frame partially-masked periods.

38. The image display system as claimed in claim 37, wherein the front-end system circuit operates in a power down mode or a power saving mode when the front-end system circuit does not generate the image signal of the input signal, and the front-end system circuit operates in a power on mode when the front-end system circuit generates the image signal of the input signal.

39. The image display system as claimed in claim 37, wherein no matter whether the front-end system circuit generates the image signal of the input signal, the front-end system circuit operates in a power on mode.

40. The image display system as claimed in claim 30, wherein the image signal of the input signal received by the timing control circuit is not masked, and the timing control circuit determines whether the image signal corresponds to the static image, such that according to a determination result, the timing control circuit does not mask the image signal but outputs the image signal of the output signal during the first time interval of each of the frame partially-masked periods, and the timing control circuit masks the image signal but does not output the image signal of the output signal during the second time interval of each of the frame partially-masked periods.

41. The image display system as claimed in claim 30, wherein after receiving the input signal, timing control circuit temporarily stores one or more frame data of the image signal and generates the output signal according to the one or more temporarily stored frame data.

42. The image display system as claimed in claim 30, after receiving the input signal, the timing control circuit does not temporarily store one or more frame data of the image signal but instead generates the output signal directly according to the one or more frame data of the image signal.

43. The image display system as claimed in claim 30, wherein the timing control circuit operates in at least one of the following four modes which comprise:
a panel self refresh (PSR) mode, wherein in the PSR mode, the front-end system circuit determines whether the image signal corresponds to the static image, and the front-end system circuit instructs the timing control circuit to temporarily store one or more frame data of the image signal first after the timing control circuit receives the input signal when the image signal corresponds to the static image, and the front-end system circuit instructs the timing control circuit to generate the output signal according to the one or more temporarily stored frame data during the first time interval of each of the frame partially-masked periods, and the front-end system circuit instructs the timing control circuit to mask the image signal but not to output the image signal of the output signal during the second time interval of each of the frame partially-masked periods.
a normal determination mode, wherein in the normal determination mode, the timing control circuit self-determines whether the image corresponding to the input signal is the static image, such that after receiving the input signal, the timing control circuit generates the output signal according to a determination result and directly according to the one or more frame data of the image signal during the first time interval of each of the frame partially-masked periods, and the timing control circuit masks the image signal during the second time interval of each of the frame partially-masked periods;
a frame buffer determination mode, wherein in the frame buffer determination mode, the timing control circuit self-determines whether the image corresponding to the input signal is a static image, and when the image signal corresponding to the static image, the timing control circuit temporarily stores one or more frame data of the image signal first after the timing control circuit receives the input signal, and the timing control circuit generates the output signal according to the one or more temporarily stored one or more frame data during the first time interval of each of the frame partially-masked periods, and the timing control circuit masks the image signal during the second time interval of each of the frame partially-masked periods; and
a system determination mode, wherein in the system determination mode, the front-end system circuit determines whether the image signal corresponds to the static image, such that according to a determination result, the front-end system circuit does not mask but outputs the image signal of the input signal, and the timing control circuit outputs the image signal of the output signal directly according to the image signal of the input signal during the first time interval of each of the frame partially-masked periods, and the front-end system circuit masks but does not output the image signal of the input signal, and the timing control circuit does not output the image signal of the output signal in response to the masked input signal during the second time interval of each of the frame partially-masked periods.

44. The image display system as claimed in claim 30, wherein a frame rate of the image signal is adjusted to be lower than that of the image signal corresponding to a dynamic image during each of the frame partially-masked periods.

45. A display driving method, comprising:
(i) receiving an input signal, wherein the input signal comprises an image signal;
(ii) generating an output signal according to the input signal, wherein the output signal comprises the image signal and is configured to drive a source driver circuit;
(iii) determining whether the image signal corresponds to a static image; and
(iv) arranging one or more frame partially-masked periods during a period when the image signal corresponds to the static image, wherein each of the frame partially-masked periods comprises a first time interval and a second time interval, the image signal of the output signal is not masked but output during the first time interval, and the image signal of the output signal is masked but not output during the second time interval.

46. The display driving method as claimed in claim 45, wherein N frame data of the image signal is not masked during the first time interval of each of the frame partially-masked periods, and M frame data of the image signal is masked during the second time interval of each of the frame partially-masked periods, wherein M and N are positive integers.

47. The display driving method as claimed in claim 45, further comprising:
masking the image signal of the input signal during the second time interval of each of the frame partially-masked periods.

48. The display driving method as claimed in claim 45, further comprising:
stopping generating the image signal of the input signal during the entire time of each of the frame partially-masked periods.

49. The display driving method as claimed in claim 45, wherein step (iii) is performed before step (i).

50. The display driving method as claimed in claim 45, wherein step (iii) is performed after step (i).

51. The display driving method as claimed in claim 45, further comprising:
adjusting a frame rate of the image signal to be lower than that of the image signal corresponding to a dynamic image during each of the frame partially-masked periods.
